(19) United States
(12) Patent Application Publication
(10) Pub. No.: US 2024/0161225 A1
(43) Pub. Date: May 16, 2024

(54) Communicating Pre-rendered Media

(71) Applicant: QUALCOMM Incorporated, San Diego, CA (US)

(72) Inventors: Imed BOUAZIZI, Frisco, TX (US); Thomas STOCKHAMMER, Bergen (DE)

(21) Appl. No.: 18/506,024

(22) Filed: Nov. 9, 2023

Related U.S. Application Data
(60) Provisional application No. 63/383,478, filed on Nov. 11, 2022.

(51) Int. Cl. G06T 1/20; G06F 3/01; G06T 11/00; H04W 28/02

(52) U.S. Cl. CPC G06T 1/20; G06F 3/013; G06T 11/00; H04W 28/0278; G06T 2200/16; G06T 2210/61

(57) ABSTRACT

Embodiments of systems and methods for communicating rendered media to a user equipment (UE) may include generating pre-rendered content for processing by the UE based on pose information received from the UE, generating, based on the pre-rendered content, description information that is configured to enable the UE to perform rendering operations using the pre-rendered content, and transmitting to the UE the description information and the pre-rendered content.

### RELATED APPLICATIONS

This application claims the benefit of priority to U.S. Provisional Application No. 63/383,478 entitled “Communicating Pre-rendered Media” filed Nov. 11, 2022, the entire contents of which are hereby incorporated by reference for all purposes.

### BACKGROUND

Devices such as augmented reality (AR) glasses can execute applications that provide a rich media or multimedia output. However, the applications that generate AR output and other similar output require large amounts of computations to be performed in relatively short time periods. Some endpoint devices are unable to perform such computations under such constraints. To accomplish such computations, some endpoint devices may send portions of a computation workload to another computing device and receive finished computational output from the other computing device. In some contexts, such as AR, virtual reality gaming, and other similarly computationally intensive implementations, such collaborative processing may be referred to as “split rendering.”

### SUMMARY

Various aspects include methods and network computing devices configured to perform the methods for communicating information needed to enable communicating rendered media to a user equipment (UE). Various aspects may include receiving pose information from the UE, generating pre-rendered content for processing by the UE based on the pose information received from the UE, generating, based on the pre-rendered content, description information that is configured to enable the UE to perform rendering operations using the pre-rendered content, transmitting the description information to the UE, and transmitting the pre-rendered content to the UE.

In some aspects, the description information may be configured to indicate buffer information for one or more buffers by which the network computing device will stream the pre-rendered content. In some aspects, the description information may be configured to indicate view configuration information for the pre-rendered content. In some aspects, the description information may be configured to indicate an array of layer view objects. In some aspects, the description information may be configured to indicate eye visibility information for the pre-rendered content. In some aspects, the description information may be configured to indicate composition layer information for the pre-rendered content. In some aspects, the description information may be configured to indicate composition layer type information for the pre-rendered content. In some aspects, the description information may be configured to indicate audio configuration properties for the pre-rendered content.

Some aspects may include receiving from the UE an uplink data description that may be configured to indicate information about the content to be pre-rendered for processing by the UE, wherein generating the pre-rendered content for processing by the UE based on pose information received from the UE may include generating the pre-rendered content based on the uplink data description. In some aspects, transmitting to the UE the description information may include transmitting to the UE a packet header extension including information that may be configured to enable the UE to process the pre-rendered content. In some aspects, transmitting to the UE the description information may include transmitting to the UE a data channel message including information that may be configured to enable the UE to process the pre-rendered content.

Further aspects include a network computing device having a memory and a processing system including one or more processors configured to perform one or more operations of any of the methods summarized above. Further aspects include a network computing device configured with processor-executable instructions to perform operations of any of the methods summarized above. Further aspects include a non-transitory processor-readable storage medium having stored thereon processor-executable instructions configured to cause a processor of a network computing device to perform operations of any of the methods summarized above. Further aspects include a network computing device having means for performing functions of any of the methods summarized above. Further aspects include a system on chip for use in a network computing device and that includes a processor configured to perform one or more operations of any of the methods summarized above.

Further aspects include methods performed by a processor of a UE may include, sending pose information to a network computing device, receiving from the network computing device description information that is configured to enable the UE to perform rendering operations using pre-rendered content, and sending rendered frames to an extended reality (XR) runtime for composition and display. Some aspects may further include transmitting information about UE capabilities and configuration to the network computing device, and receiving from the network computing device a scene description for a split rendering session. Some aspects may further include determining whether to select a 3D rendering configuration or a 2D rendering configuration based at least in part on the received scene description, receiving pre-rendered content via buffers described in a description information extension of the scene description in response to determining to select the 2D rendering configuration, receiving information for rendering 3D scene images and rendering the one or more 3D scene images in response to determining to select the 3D rendering configuration.

Further aspects include a UE having a processor configured to perform one or more operations of any of the methods summarized above. Further aspects include a UE configured with processor-executable instructions to perform operations of any of the methods summarized above. Further aspects include a non-transitory processor-readable storage medium having stored thereon processor-executable instructions configured to cause a processor of a UE to perform operations of any of the methods summarized above. Further aspects include a UE having means for performing functions of any of the methods summarized above. Further aspects include a system on chip for use in a UE and that includes a processor configured to perform one or more operations of any of the methods summarized above.

### BRIEF DESCRIPTION OF THE DRAWINGS

FIG. 1A is a system block diagram illustrating an example communications system suitable for implementing any of the various embodiments.

FIG. 1B is a system block diagram illustrating an example disaggregated base station architecture suitable for implementing any of the various embodiments.

FIG. 1C is a system block diagram illustrating an example of split rendering operations suitable for implementing any of the various embodiments.

FIG. 2 is a component block diagram illustrating an example computing and wireless modem system suitable for implementing any of the various embodiments.

FIG. 3 is a component block diagram illustrating a software architecture including a radio protocol stack for the user and control planes in wireless communications suitable for implementing any of the various embodiments.

FIG. 4A is a conceptual diagram illustrating operations performed by an application and an XR runtime according to various embodiments.

FIG. 4B is a block diagram illustrating operations of a render loop that may be performed by an XR system according to various embodiments.

FIG. 4C is a conceptual diagram illustrating XR device views according to various embodiments.

FIG. 4D is a conceptual diagram illustrating operations performed by compositor according to various embodiments.

FIG. 4E is a conceptual diagram illustrating an extension configured to include description information according to various embodiments.

FIGS. 5A-5G illustrates aspects of description information according to various embodiments.

FIG. 6A is a process flow diagram illustrating a method performed by a processor of a network computing device for communicating pre-rendered media to a UE according to various embodiments.

FIG. 6B is a process flow diagram illustrating operations that may be performed by a processor of a network element as part of the method for communicating pre-rendered media to a UE according to various embodiments.

FIG. 6C is a process flow diagram illustrating operations that may be performed by a processor of a UE according to various embodiments.

FIG. 7 is a component block diagram of a network computing device suitable for use with various embodiments.

FIG. 8 is a component block diagram of a UE suitable for use with various embodiments.

FIG. 9 is a component block diagram of a UE suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments may include computing devices that are configured to perform operations for communicating information needed to enable communicating rendered media to a user equipment including generating, based on a generated image, description information that is configured to enable the UE to present rendered content, and transmitting to the UE the description information and the rendered content. In various embodiments the description information may be configured to indicate buffer information for one or more buffers by which the network computing device will stream the rendered content, view configuration information for the rendered content, an array of layer view objects, eye visibility information for the rendered content, composition layer information for the rendered content, composition layer type information for the rendered content, and/or audio configuration properties for the rendered content.

The terms “network computing device” or “network element” are used herein to refer to any one or all of a computing device that is part of or in communication with a communication network, such as a server, a router, a gateway, a hub device, a switch device, a bridge device, a repeater device, or another electronic device that includes a memory, communication components, and a programmable processor.

The term “user equipment” (UE) is used herein to refer to any one or all of computing devices, wireless devices, cellular telephones, smartphones, portable computing devices, personal or mobile multi-media players, laptop computers, tablet computers, smartbooks, ultrabooks, palmtop computers, smart glasses, XR devices, wireless electronic mail receivers, multimedia Internet-enabled cellular telephones, medical devices and equipment, biometric sensors/devices, wearable devices including smart watches, smart clothing, smart wrist bands, smart jewelry (for example, smart rings and smart bracelets), entertainment devices (for example, wireless gaming controllers, music and video players, satellite radios, etc.), wireless-network enabled Internet of Things (IoT) devices including smart meters/sensors, industrial manufacturing equipment, large and small machinery and appliances for home or enterprise use, wireless communication elements within autonomous and semiautonomous vehicles, wireless devices affixed to or incorporated into various mobile platforms, global positioning system devices, and similar electronic devices that include a memory, wireless communication components and a programmable processor.

As used herein, the terms “network,” “communication network,” and “system” may interchangeably refer to a portion or all of a communications network or internetwork. A network may include a plurality of network elements. A network may include a wireless network, and/or may support one or more functions or services of a wireless network.

As used herein, “wireless network,” “cellular network,” and “wireless communication network” may interchangeably refer to a portion or all of a wireless network of a carrier associated with a wireless device and/or subscription on a wireless device. The techniques described herein may be used for various wireless communication networks, such as Code Division Multiple Access (CDMA), time division multiple access (TDMA), FDMA, orthogonal FDMA (OFDMA), single carrier FDMA (SC-FDMA) and other networks. In general, any number of wireless networks may be deployed in a given geographic area. Each wireless network may support at least one radio access technology, which may operate on one or more frequency or range of frequencies. For example, a CDMA network may implement Universal Terrestrial Radio Access (UTRA) (including Wideband Code Division Multiple Access (WCDMA) standards), CDMA2000 (including IS-2000, IS-95 and/or IS-856 standards), etc. In another example, a TDMA network may implement GSM Enhanced Data rates for GSM Evolution (EDGE). In another example, an OFDMA network may implement Evolved UTRA (E-UTRA) (including LTE standards), Institute of Electrical and Electronics Engineers (IEEE) 802.11 (Wi-Fi), IEEE 802.16 (WiMAX), IEEE 802.20, Flash-OFDM®, etc. Reference may be made to wireless networks that use LTE standards, and therefore the terms “Evolved Universal Terrestrial Radio Access,” “E-UTRAN” and “eNodeB” may also be used interchangeably herein to refer to a wireless network. However, such references are provided merely as examples, and are not intended to exclude wireless networks that use other communication standards. For example, while various Third Generation (3G) systems, Fourth Generation (4G) systems, and Fifth Generation (5G) systems are discussed herein, those systems are referenced merely as examples and future generation systems (e.g., sixth generation (6G) or higher systems) may be substituted in the various examples.

The term “system on chip” (SOC) is used herein to refer to a single integrated circuit (IC) chip that contains multiple resources or processors integrated on a single substrate. A single SOC may contain circuitry for digital, analog, mixed-signal, and radio-frequency functions. A single SOC also may include any number of general purpose or specialized processors (digital signal processors, modem processors, video processors, etc.), memory blocks (such as ROM, RAM, Flash, etc.), and resources (such as timers, voltage regulators, oscillators, etc.). SOCs also may include software for controlling the integrated resources and processors, as well as for controlling peripheral devices.

The term “system in a package” (SIP) may be used herein to refer to a single module or package that contains multiple resources, computational units, cores or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP also may include multiple independent SOCs coupled together via high speed communication circuitry and packaged in close proximity, such as on a single motherboard or in a single wireless device. The proximity of the SOCs facilitates high speed communications and the sharing of memory and resources.

Endpoint UEs may be configured to execute a variety of extended reality (XR) applications. XR may include or refer to a variety of services, including virtual reality (VR), augmented reality (AR), mixed reality (MR), and other similar services. The operations performed by applications that generate XR output and other similar output are computationally intensive and require large amounts of computation to be performed in relatively short time periods (e.g., ray and path tracing, global illumination calculations, dynamic scene lighting, etc.). Some UEs are unable to meet a required computational burden. In some embodiments, the UE may send portions of a computation workload to another computing device and receive finished computational output from the other computing device. In some embodiments, the UE may request that another computing device generate or pre-render image information for the UE to use in rendering a scene, display, or video frame. In some contexts, such as XR applications, such collaborative processing may be referred to as “split rendering.” In various embodiments, the other computing device may perform a variety of pre-rendering operations and provide to the UE pre-rendered content as well as information (e.g., such as metadata or other suitable information) configured to enable the UE to use the pre-rendered content in rendering a scene, display, or video frame.

In some split rendering operations, the UE may transmit to the network computing device information about the view of the UE (e.g., the UEs pose and/or field of view) and composition layer capabilities of the UE, as well as information about the UE's rendering capabilities. The network computing device may pre-render content (e.g., images, image elements or visual, audio, and/or haptic elements) according to rendering format(s) matching the UE's rendering capabilities and provide to the UE a scene description document that includes information about the rendering formats and about where to access the streams (i.e., a network location) to obtain the pre-rendered content. The UE may select an appropriate rendering format that matches the UE's capabilities and perform rendering operations using the pre-rendered content to render an image, display, or video frame, such as augmented reality imagery in the case of an AR/XR application.

To communicate information to and from XR applications, UEs and network computing devices may use an interface protocol such as OpenXR. In some embodiments, the protocol may provide an Application Programming Interface (API) that enables communication among XR applications, XR device hardware, and XR rendering systems (sometimes referred to as an “XR runtime”). Although various examples and embodiments are explained herein referring to OpenXR as an example, this is not intended as a limitation, and various embodiments may employ various interface protocols and other operations for communication with XR applications.

In OpenXR, and XR application may send a query message to an XR system. In response, the XR system may create an instance (e.g., an Xrinstance) and may generate a session for the XR application (e.g., an XrSession). The application may then initiate a rendering loop. The application may wait for a display frame opportunity (e.g., xrWaitFrame) and signal the start of a frame rendering (e.g., xrBeginFrame). When rendering is complete, a swap chain may be handed over to a compositor (e.g., xrEndFrame) or another suitable function of the XR runtime that is configured to fuse (combine) images from multiple sources into a frame. A “swap chain” is a plurality of memory buffers used for displaying image frames by a device. Each time an application presents a new frame for display, the first buffer in the swap chain takes the place of the displayed buffer. This process is referred to as swapping or flipping. Swap chains (e.g., xrSwapchains) may be limited by the capabilities of the XR system (e.g., xrSystem). Swap chains may be customized when they are created based on requirements of the XR application.

Information about the view of the UE also may be provided to the XR system. For example, a smart phone or tablet executing in XR application may provide a single view on a touchscreen display, while AR glasses or VR goggles may provide two views, such as a stereoscopic view, by presenting a view for each of a user's eyes. Information about the UE's view capabilities may be enumerated for the XR system.

The XR runtime may include a compositor that is responsible for, among other things, composing layers, re-projecting layers, applying lens distortion, and sending final images to the UE for display. In some embodiments, in XR application may use multiple layers. Various compositors may support a variety of composition layer types, such as stereo, quad (e.g., 2-dimensional planes in 3-dimensional space), cubemap, equirectangular, cylinder, depth, alpha blend, and/or other vendor composition layers.

When operating in split rendering mode, the computing device requested by the UE to perform pre-rendering operations needs to know information about the UE view and UE composition layer capabilities, and may negotiate configurations will be used based on such information. Further, because the computing device may stream the produced pre-rendered content (e.g., images, image elements or visual, audio, and/or haptic elements) to the UE, the computing device also requires information about the streams. Such configurations may be static or dynamic.

Various embodiments include methods and network computing devices configured to perform the methods of communicating pre-rendered media content to a UE. Various embodiments enable the network computing device to describe the output of a pre-rendering operation to a UE (“pre-rendered content”). The pre-rendered content may include images, audio information, haptic information, or other information that the UE may process for presentation to a user by performing rendering operations. In various embodiments, the pre-rendered content output may be streamed by the network computing device (functioning as a pre-rendering server device) to the UE via one or more streamed buffers, such as one or more visual data buffers, one or more audio data buffers, one or more haptic data buffers, and/or the like. The network computing device may describe the pre-rendered content in a scene description document (“description information”) that the network computing device transmits to the UE. The network computing device may update the description information dynamically, such as during the lifetime of a split rendering session. Additionally, the UE may provide to the network computing device a description of information (data) transmitted from the UE to the network computing device as input with which the network computing device will perform pre-rendering operations. The UE may transmit such information (data) as one or more uplink streamed buffers.

In various embodiments, the network computing device may generate pre-rendered content for presentation by the UE based on pose information received from the UE, generate description information based on the generated image that is configured to enable the UE to perform rendering operations using the pre-rendered content, and transmit to the UE the description information and the pre-rendered content. In some embodiments, the network computing device may transmit the pre-rendered content by one or more streamed buffers. In some embodiments, the network computing device may configure a Graphics Language Transmission Format (glTF) extension to include information describing the buffers that convey the streamed pre-rendered content. In some embodiments, the network computing device may configure a Moving Picture Experts Group (MPEG) media extension (e.g., an MPEG_media extension) to include information describing stream sources (e.g., network location information of data stream(s)).

In some embodiments, the network computing device may configure the description information with an extension (that may be referred to as, for example, “3GPP_node_prerendered”) that describes a pre-rendered content-node type (e.g., a new OpenXR node type). In some embodiments, the pre-rendered content-node type may indicate the presence of pre-rendered content. In some embodiments, the extension may include visual, audio, and/or haptic information components or information elements. In some embodiments, each information component or information element may describe a set of buffers and related buffer configurations, such as raw formats (pre-rendered buffer data after decoding, e.g., red-green-blue-alpha (RGBA) texture images). In some embodiments, the extension may include information describing uplink buffers for conveying information from the UE to the network computing device, which may include time-dependent metadata such as UE pose information and information about user inputs. In this manner, the network computing device may send information to the UE that describes downlink streams, by which the network computing device may send description information and pre-rendered content to the UE, and uplink streams, by which the UE may send information (e.g., UE configuration information, UE capability information, UE pose information, UE field of view information, UE sensor inputs, etc.) and image information (e.g., scene description information, etc.) to the network computing device.

In various embodiments, the network computing device may configure the description information to include a variety of information usable by the UE to perform rendering operations using the pre-rendered content. In some embodiments, the description information may be configured to indicate buffer information for one or more buffers by which the network computing device will stream the pre-rendered content. The buffers may include one or more streaming buffers, such as visual data buffers, audio data buffers, and/or haptics data buffers. In some embodiments, the description information may be configured to indicate view configuration information for the pre-rendered content. In some embodiments, the description information may be configured to indicate an array of layer view objects. In some embodiments, the description information may be configured to indicate eye visibility information for the pre-rendered content. In some embodiments, the description information may be configured to indicate composition layer information and/or composition layer type information for the pre-rendered content. In some embodiments, the description information may be configured to indicate audio configuration properties for the pre-rendered content.

In some embodiments, the network computing device may receive from the UE an uplink data description that is configured to indicate information about the content to be pre-rendered for processing by the UE, and may generate the pre-rendered content based on the uplink data description. In some embodiments, the network computing device may transmit to the UE a packet header extension including information that is configured to enable the UE to process the pre-rendered content. In some embodiments, the network computing device may transmit to the UE a data channel message including information that is configured to enable the UE to process the pre-rendered content.

Various embodiments improve the operation of network computing devices and UEs by enabling network computing devices and UEs to describe outputs and/or inputs for split rendering operations. Various embodiments improve the operation of network computing devices and UEs by increasing the efficiency by which UEs and network computing devices communicate information about, and perform, split rendering operations.

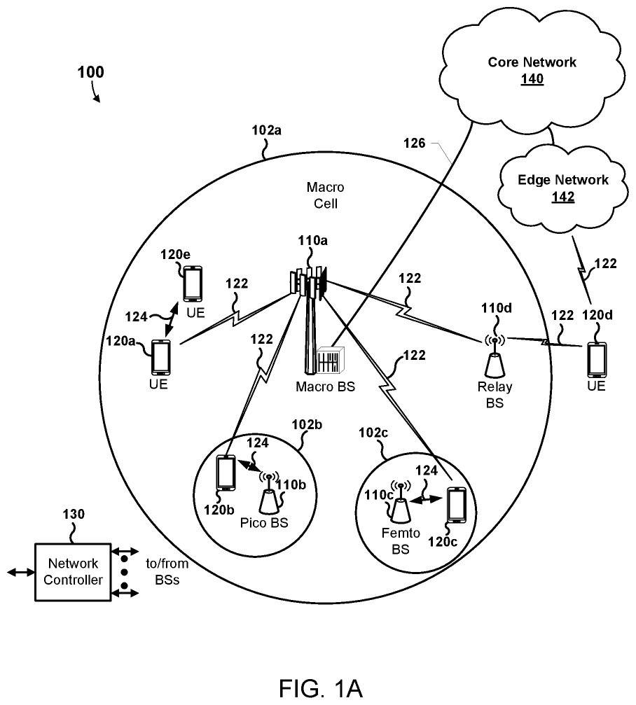

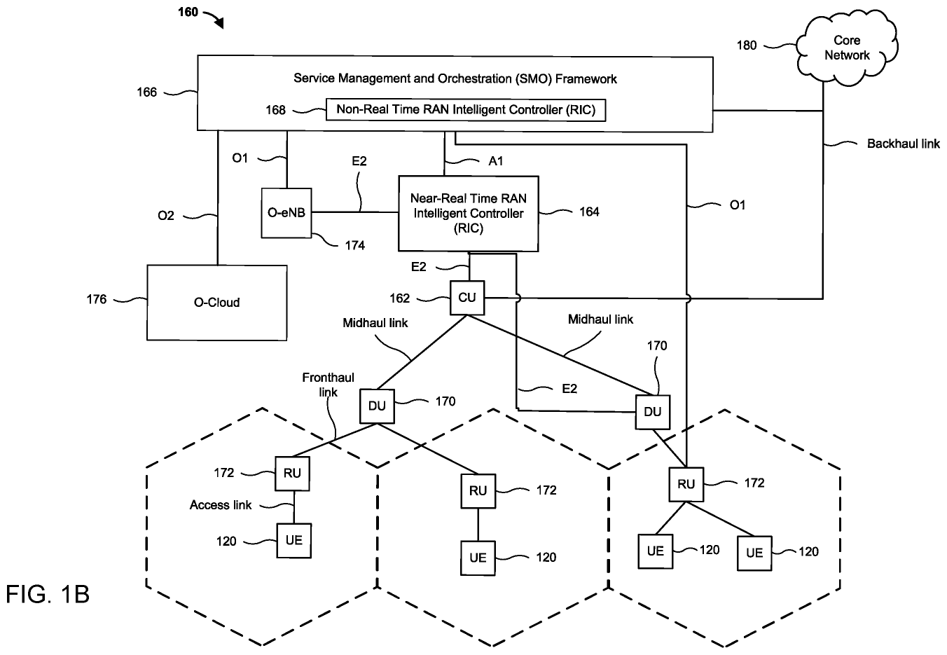

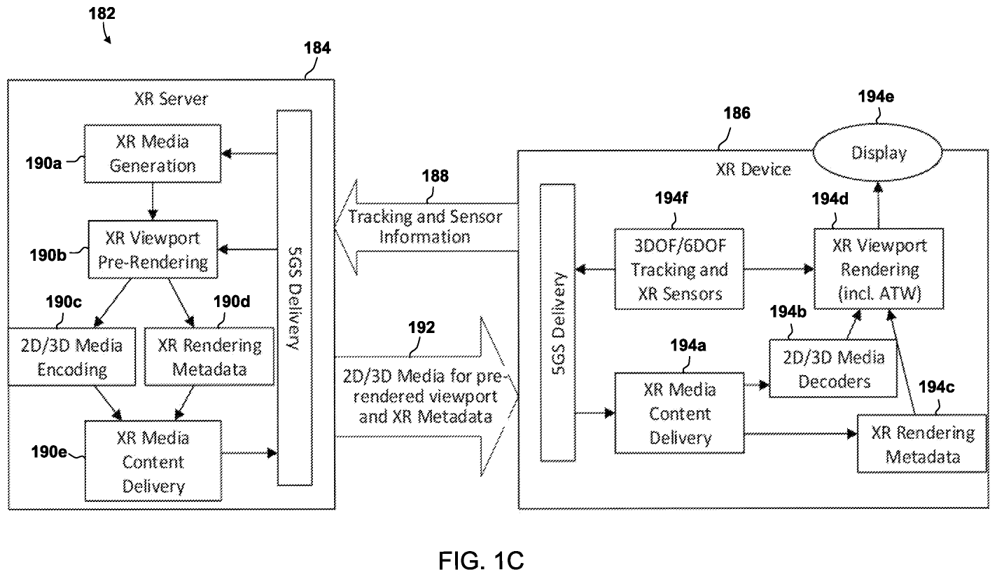

FIG. 1A is a system block diagram illustrating an example communications system 100 suitable for implementing any of the various embodiments. The communications system 100 may be a 5G New Radio (NR) network, or any other suitable network such as a Long Term Evolution (LTE) network. While FIG. 1 illustrates a 5G network, later generation networks may include the same or similar elements. Therefore, the reference to a 5G network and 5G network elements in the following descriptions is for illustrative purposes and is not intended to be limiting.

The communications system 100 may include a heterogeneous network architecture that includes a core network 140 and a variety of wireless devices (illustrated as user equipment (UE) 120a-120e in FIG. 1). The communications system 100 may include an Edge network 142 provide network computing resources in proximity to the wireless devices. The communications system 100 also may include a number of base stations (illustrated as the BS 110a, the BS 110b, the BS 110c, and the BS 110d) and other network entities. A base station is an entity that communicates with wireless devices, and also may be referred to as a Node B, an LTE Evolved nodeB (eNodeB or eNB), an access point (AP), a radio head, a transmit receive point (TRP), a New Radio base station (NR BS), a 5G NodeB (NB), a Next Generation NodeB (gNodeB or gNB), or the like. Each base station may provide communication coverage for a particular geographic area. In 3GPP, the term “cell” can refer to a coverage area of a base station, a base station subsystem serving this coverage area, or a combination thereof, depending on the context in which the term is used. The core network 140 may be any type of core network, such as an LTE core network (e.g., an EPC network), 5G core network, etc.

A base station 110a-110d may provide communication coverage for a macro cell, a pico cell, a femto cell, another type of cell, or a combination thereof. A macro cell may cover a relatively large geographic area (for example, several kilometers in radius) and may allow unrestricted access by wireless devices with service subscription. A pico cell may cover a relatively small geographic area and may allow unrestricted access by wireless devices with service subscription. A femto cell may cover a relatively small geographic area (for example, a home) and may allow restricted access by wireless devices having association with the femto cell (for example, wireless devices in a closed subscriber group (CSG)). A base station for a macro cell may be referred to as a macro BS. A base station for a pico cell may be referred to as a pico BS. A base station for a femto cell may be referred to as a femto BS or a home BS. In the example illustrated in FIG. 1, a base station 110a may be a macro BS for a macro cell 102a, a base station 110b may be a pico BS for a pico cell 102b, and a base station 110c may be a femto BS for a femto cell 102c. A base station 110a-110d may support one or multiple (for example, three) cells. The terms “eNB”, “base station”, “NR BS”, “gNB”, “TRP”, “AP”, “node B”, “5G NB”, and “cell” may be used interchangeably herein.

In some examples, a cell may not be stationary, and the geographic area of the cell may move according to the location of a mobile base station. In some examples, the base stations 110a-110d may be interconnected to one another as well as to one or more other base stations or network nodes (not illustrated) in the communications system 100 through various types of backhaul interfaces, such as a direct physical connection, a virtual network, or a combination thereof using any suitable transport network

The base station 110a-110d may communicate with the core network 140 over a wired or wireless communication link 126. The wireless device 120a-120e may communicate with the base station 110a-110d over a wireless communication link 122.

The wired communication link 126 may use a variety of wired networks (such as Ethernet, TV cable, telephony, fiber optic and other forms of physical network connections) that may use one or more wired communication protocols, such as Ethernet, Point-To-Point protocol, High-Level Data Link Control (HDLC), Advanced Data Communication Control Protocol (ADCCP), and Transmission Control Protocol/Internet Protocol (TCP/IP).

The communications system 100 also may include relay stations (such as relay BS 110d). A relay station is an entity that can receive a transmission of data from an upstream station (for example, a base station or a wireless device) and send a transmission of the data to a downstream station (for example, a wireless device or a base station). A relay station also may be a wireless device that can relay transmissions for other wireless devices. In the example illustrated in FIG. 1, a relay station 110d may communicate with macro the base station 110a and the wireless device 120d in order to facilitate communication between the base station 110a and the wireless device 120d. A relay station also may be referred to as a relay base station, a relay base station, a relay, etc.

The communications system 100 may be a heterogeneous network that includes base stations of different types, for example, macro base stations, pico base stations, femto base stations, relay base stations, etc. These different types of base stations may have different transmit power levels, different coverage areas, and different impacts on interference in communications system 100. For example, macro base stations may have a high transmit power level (for example, 5 to 40 Watts) whereas pico base stations, femto base stations, and relay base stations may have lower transmit power levels (for example, 0.1 to 2 Watts).

A network controller 130 may couple to a set of base stations and may provide coordination and control for these base stations. The network controller 130 may communicate with the base stations via a backhaul. The base stations also may communicate with one another, for example, directly or indirectly via a wireless or wireline backhaul.

The wireless devices 120a, 120b, 120c may be dispersed throughout communications system 100, and each wireless device may be stationary or mobile. A wireless device also may be referred to as an access terminal, a terminal, a mobile station, a subscriber unit, a station, user equipment (UE), etc.

A macro base station 110a may communicate with the communication network 140 over a wired or wireless communication link 126. The wireless devices 120a, 120b, 120c may communicate with a base station 110a-110d over a wireless communication link 122.

The wireless communication links 122 and 124 may include a plurality of carrier signals, frequencies, or frequency bands, each of which may include a plurality of logical channels. The wireless communication links 122 and 124 may utilize one or more radio access technologies (RATs). Examples of RATs that may be used in a wireless communication link include 3GPP LTE, 3G, 4G, 5G (such as NR), GSM, Code Division Multiple Access (CDMA), Wideband Code Division Multiple Access (WCDMA), Worldwide Interoperability for Microwave Access (WiMAX), Time Division Multiple Access (TDMA), and other mobile telephony communication technologies cellular RATs. Further examples of RATs that may be used in one or more of the various wireless communication links within the communication system 100 include medium range protocols such as Wi-Fi, LTE-U, LTE-Direct, LAA, MuLTEfire, and relatively short range RATs such as ZigBee, Bluetooth, and Bluetooth Low Energy (LE).

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block”) may be 12 subcarriers (or 180 kHz). Consequently, the nominal Fast File Transfer (FFT) size may be equal to 128, 256, 512, 1024 or 2048 for system bandwidth of 1.25, 2.5, 5, 10 or 20 megahertz (MHz), respectively. The system bandwidth also may be partitioned into subbands. For example, a subband may cover 1.08 MHz (i.e., 6 resource blocks), and there may be 1, 2, 4, 8 or 16 subbands for system bandwidth of 1.25, 2.5, 5, 10 or 20 MHz, respectively.

While descriptions of some implementations may use terminology and examples associated with LTE technologies, some implementations may be applicable to other wireless communications systems, such as a new radio (NR) or 5G network. NR may utilize OFDM with a cyclic prefix (CP) on the uplink (UL) and downlink (DL) and include support for half-duplex operation using Time Division Duplex (TDD). A single component carrier bandwidth of 100 MHz may be supported. NR resource blocks may span 12 sub-carriers with a sub-carrier bandwidth of 75 kHz over a 0.1 millisecond (ms) duration. Each radio frame may consist of 50 subframes with a length of 10 ms. Consequently, each subframe may have a length of 0.2 ms. Each subframe may indicate a link direction (i.e., DL or UL) for data transmission and the link direction for each subframe may be dynamically switched. Each subframe may include DL/UL data as well as DL/UL control data. Beamforming may be supported and beam direction may be dynamically configured. Multiple Input Multiple Output (MIMO) transmissions with precoding also may be supported. MIMO configurations in the DL may support up to eight transmit antennas with multi-layer DL transmissions up to eight streams and up to two streams per wireless device. Multi-layer transmissions with up to 2 streams per wireless device may be supported. Aggregation of multiple cells may be supported with up to eight serving cells. Alternatively, NR may support a different air interface, other than an OFDM-based air interface.

Some wireless devices may be considered machine-type communication (MTC) or evolved or enhanced machine-type communication (eMTC) wireless devices. MTC and eMTC wireless devices include, for example, robots, drones, remote devices, sensors, meters, monitors, location tags, etc., that may communicate with a base station, another device (for example, remote device), or some other entity. A wireless computing platform may provide, for example, connectivity for or to a network (for example, a wide area network such as Internet or a cellular network) via a wired or wireless communication link. Some wireless devices may be considered Internet-of-Things (IoT) devices or may be implemented as NB-IoT (narrowband internet of things) devices. The wireless device 120a-120e may be included inside a housing that houses components of the wireless device 120a-120e, such as processor components, memory components, similar components, or a combination thereof.

In general, any number of communications systems and any number of wireless networks may be deployed in a given geographic area. Each communications system and wireless network may support a particular radio access technology (RAT) and may operate on one or more frequencies. A RAT also may be referred to as a radio technology, an air interface, etc. A frequency also may be referred to as a carrier, a frequency channel, etc. Each frequency may support a single RAT in a given geographic area in order to avoid interference between communications systems of different RATs. In some cases, 4G/LTE and/or 5G/NR RAT networks may be deployed. For example, a 5G non-standalone (NSA) network may utilize both 4G/LTE RAT in the 4G/LTE RAN side of the 5G NSA network and 5G/NR RAT in the 5G/NR RAN side of the 5G NSA network. The 4G/LTE RAN and the 5G/NR RAN may both connect to one another and a 4G/LTE core network (e.g., an evolved packet core (EPC) network) in a 5G NSA network. Other example network configurations may include a 5G standalone (SA) network in which a 5G/NR RAN connects to a 5G core network.

In some implementations, two or more wireless devices 120a-120e (for example, illustrated as the wireless device 120a and the wireless device 120e) may communicate directly using one or more sidelink channels 124 (for example, without using a base station 110a-110d as an intermediary to communicate with one another). For example, the wireless devices 120a-120e may communicate using peer-to-peer (P2P) communications, device-to-device (D2D) communications, a vehicle-to-everything (V2X) protocol (which may include a vehicle-to-vehicle (V2V) protocol, a vehicle-to-infrastructure (V2I) protocol, or similar protocol), a mesh network, or similar networks, or combinations thereof. In this case, the wireless device 120a-120e may perform scheduling operations, resource selection operations, as well as other operations described elsewhere herein as being performed by the base station 110a-110d.

FIG. 1B is a system block diagram illustrating an example disaggregated base station 160 architecture suitable for implementing any of the various embodiments. With reference to FIGS. 1A and 1B, the disaggregated base station 160 architecture may include one or more central units (CUs) 162 that can communicate directly with a core network 180 via a backhaul link, or indirectly with the core network 180 through one or more disaggregated base station units, such as a Near-Real Time (Near-RT) RAN Intelligent Controller (RIC) 164 via an E2 link, or a Non-Real Time (Non-RT) RIC 168 associated with a Service Management and Orchestration (SMO) Framework 166, or both. A CU 162 may communicate with one or more distributed units (DUs) 170 via respective midhaul links, such as an F1 interface. The DUs 170 may communicate with one or more radio units (RUs) 172 via respective fronthaul links. The RUs 172 may communicate with respective UEs 120 via one or more radio frequency (RF) access links. In some implementations, the UE 120 may be simultaneously served by multiple RUs 172.

Each of the units (i.e., CUs 162, DUs 170, RUs 172), as well as the Near-RT RICs 164, the Non-RT RICs 168 and the SMO Framework 166, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 162 may host one or more higher layer control functions. Such control functions may include the radio resource control (RRC), packet data convergence protocol (PDCP), service data adaptation protocol (SDAP), or the like. Each control function may be implemented with an interface configured to communicate signals with other control functions hosted by the CU 162. The CU 162 may be configured to handle user plane functionality (i.e., Central Unit-User Plane (CU-UP)), control plane functionality (i.e., Central Unit-Control Plane (CU-CP)), or a combination thereof. In some implementations, the CU 162 can be logically split into one or more CU-UP units and one or more CU-CP units. The CU-UP unit can communicate bidirectionally with the CU-CP unit via an interface, such as the E1 interface when implemented in an O-RAN configuration. The CU 162 can be implemented to communicate with DUs 170, as necessary, for network control and signaling.

The DU 170 may correspond to a logical unit that includes one or more base station functions to control the operation of one or more RUs 172. In some aspects, the DU 170 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 170 may further host one or more low PHY layers. Each layer (or module) may be implemented with an interface configured to communicate signals with other layers (and modules) hosted by the DU 170, or with the control functions hosted by the CU 162.

Lower-layer functionality may be implemented by one or more RUs 172. In some deployments, an RU 172, controlled by a DU 170, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 172 may be implemented to handle over the air (OTA) communication with one or more UEs 120. In some implementations, real-time and non-real-time aspects of control and user plane communication with the RU(s) 172 may be controlled by the corresponding DU 170. In some scenarios, this configuration may enable the DU(s) 170 and the CU 162 to be implemented in a cloud-based radio access network (RAN) architecture, such as a virtual RAN (vRAN) architecture.

The SMO Framework 166 may be configured to support RAN deployment and provisioning of non-virtualized and virtualized network elements. For non-virtualized network elements, the SMO Framework 166 may be configured to support the deployment of dedicated physical resources for RAN coverage requirements, which may be managed via an operations and maintenance interface (such as an O1 interface). For virtualized network elements, the SMO Framework 166 may be configured to interact with a cloud computing platform (such as an open cloud (O-Cloud) 176) to perform network element life cycle management (such as to instantiate virtualized network elements) via a cloud computing platform interface (such as an O2 interface). Such virtualized network elements can include, but are not limited to, CUs 162, DUs 170, RUs 172 and Near-RT RICs 164. In some implementations, the SMO Framework 166 may communicate with a hardware aspect of a 4G RAN, such as an open eNB (O-eNB) 174, via an O1 interface. Additionally, in some implementations, the SMO Framework 166 may communicate directly with one or more RUs 172 via an O1 interface. The SMO Framework 166 also may include a Non-RT RIC 168 configured to support functionality of the SMO Framework 166.

The Non-RT RIC 168 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 164. The Non-RT RIC 168 may be coupled to or communicate with (such as via an A1 interface) the Near-RT RIC 164. The Near-RT RIC 164 may be configured to include a logical function that enables near-real-time control and optimization of RAN elements and resources via data collection and actions over an interface (such as via an E2 interface) connecting one or more CUs 162, one or more DUs 170, or both, as well as an O-eNB, with the Near-RT RIC 164.

In some implementations, to generate AI/ML models to be deployed in the Near-RT RIC 164, the Non-RT RIC 168 may receive parameters or external enrichment information from external servers. Such information may be utilized by the Near-RT RIC 164 and may be received at the SMO Framework 166 or the Non-RT RIC 168 from non-network data sources or from network functions. In some examples, the Non-RT RIC 168 or the Near-RT RIC 164 may be configured to tune RAN behavior or performance. For example, the Non-RT RIC 168 may monitor long-term trends and patterns for performance and employ AI/ML models to perform corrective actions through the SMO Framework 166 (such as reconfiguration via 01) or via creation of RAN management policies (such as A1 policies).

FIG. 1C is a system block diagram illustrating an example system 182 configured to perform split rendering operations suitable for implementing any of the various embodiments. With reference to FIGS. 1A-1C, the system 182 may include a network computing device 184 (“XR Server”) and a UE 186 (“XR Device”). In various embodiments, the network computing device 184 may perform operations to prerender content (e.g., image data for a 3D scene) into a simpler format that may be transmitted to and processed by the UE 186. In some embodiments, the UE 186 may receive the prerendered content and perform operations for rendering content. The rendering operations performed by the UE 186 may include final rendering of image data based on local correction processes, local pose correction operations, and other suitable processing operations.

In various embodiments, the UE 186 may transmit to the network computing device 184 tracking and sensor information 188, such as an orientation of the UE 186 (e.g., a rotation of the pose), field-of-view information for the UE 186, three-dimensional coordinates of an image's pose, and other suitable information. Using the tracking and sensor information 188, the network computing device 184 may perform operations to pre-render content. In some embodiments, the network computing device 184 may perform operations 190a to generate XR media, and operations 190b to perform pre-rendering operations of generated media based on a field-of-view and other display information of the UE 186. The network computing device 184 may perform operations 190c to encode 2D or 3D media, and/or operations 190d to generate XR rendering metadata. The network computing device 184 may perform operations 190e to prepare the encoded media and/or XR rendering metadata for transmission to the UE 186.

The network computing device 184 may transmit to the UE 186 the encoded 2D or 3D media and the XR metadata 192. The UE 186 may perform operations for rendering the prerendered content. In some embodiments, the UE 186 may perform operations 194a for receiving the encoded 2D or 3D media and the XR metadata 192. The UE 186 may perform operations 194b for decoding the 2D or 3D media, and/or operations 194c for receiving, parsing, and/or processing the XR rendering metadata. The UE 186 may perform operations 194d for rendering the 2D or 3D media using the XR rendering metadata (which operations may include asynchronous time warping (ATW) operations). In some embodiments, the UE 186 also may perform local correction operations as part of the content rendering operations. The UE 186 may perform operations 194e to display the rendered content using a suitable display device. The UE 186 also may perform operations 194f for motion and orientation tracking of the UE 186 and or receiving input from one or more sensors of the XR device 186. The UE 186 may transmit the motion and orientation tracking information and/or sensor input information to the network computing device 184 as tracking and sensor information 188.

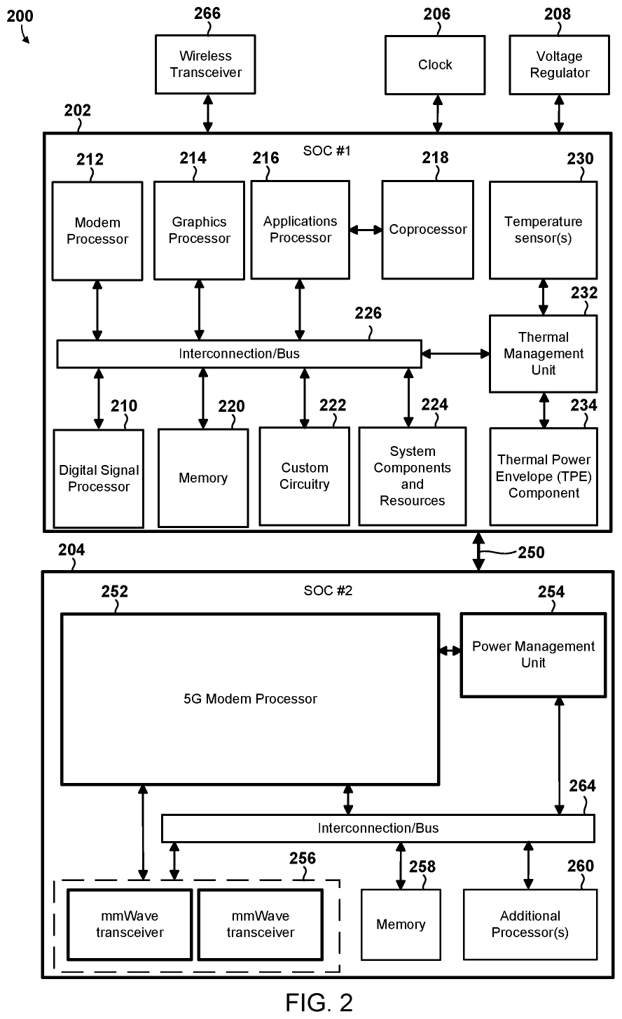

FIG. 2 is a component block diagram illustrating an example processing system 200 suitable for implementing any of the various embodiments. Various embodiments may be implemented on a processing system 200 including a number of single-core processor and multi-core processors implemented in a computing system, which may be integrated a system-on-chip (SOC) or system in a package (SIP).

With reference to FIGS. 1A-2, the illustrated example processing system 200 (which may be a SIP in some embodiments) includes a two SOC processing systems 202, 204 coupled to a clock 206, a voltage regulator 208, and a wireless transceiver 266 configured to send and receive wireless communications via an antenna (not shown) to/from a wireless device (e.g., 120a-120e) or a base station (e.g., 110a-110d). In some implementations, the first SOC processing system 202 may operate as central processing unit (CPU) of the wireless device that carries out the instructions of software application programs by performing the arithmetic, logical, control and input/output (I/O) operations specified by the instructions. In some implementations, the second processing system SOC 204 may operate as a specialized processing unit. For example, the second SOC processing system 204 may operate as a specialized 5G processing unit responsible for managing high volume, high speed (such as 5 Gbps, etc.), and/or very high frequency short wave length (such as 28 GHz mmWave spectrum, etc.) communications.

The first SOC processing system 202 may include a digital signal processor (DSP) 210, a modem processor 212, a graphics processor 214, an application processor 216, one or more coprocessors 218 (such as vector co-processor) connected to one or more of the processors, memory 220, custom circuitry 222, system components and resources 224, an interconnection/bus module 226, one or more temperature sensors 230, a thermal management unit 232, and a thermal power envelope (TPE) component 234. The second SOC processing system 204 may include a 5G modem processor 252, a power management unit 254, an interconnection/bus module 264, a plurality of mmWave transceivers 256, memory 258, and various additional processors 260, such as an applications processor, packet processor, etc.

In the processing system 200, 202, 204, each processor 210, 212, 214, 216, 218, 252, 260 may include one or more cores, and each processor/core may perform operations independent of the other processors/cores. For example, the first SOC processing system 202 may include a processor that executes a first type of operating system (such as FreeBSD, LINUX, OS X, etc.) and a processor that executes a second type of operating system (such as MICROSOFT WINDOWS 10). In addition, any or all of the processors 210, 212, 214, 216, 218, 252, 260 may be included as part of a processor cluster architecture (such as a synchronous processor cluster architecture, an asynchronous or heterogeneous processor cluster architecture, etc.).

The first and second SOC processing systems 202, 204 may include various system components, resources and custom circuitry for managing sensor data, analog-to-digital conversions, wireless data transmissions, and for performing other specialized operations, such as decoding data packets and processing encoded audio and video signals for rendering in a web browser. For example, the system components and resources 224 of the first SOC processing system 202 may include power amplifiers, voltage regulators, oscillators, phase-locked loops, peripheral bridges, data controllers, memory controllers, system controllers, access ports, timers, and other similar components used to support the processors and software clients running on a wireless device. The system components and resources 224 and/or custom circuitry 222 also may include circuitry to interface with peripheral devices, such as cameras, electronic displays, wireless communication devices, external memory chips, etc.

The first and second SOC processing systems 202, 204 may communicate via interconnection/bus module 250. The various processors 210, 212, 214, 216, 218 within each processing system may be interconnected to one or more memory elements 220, system components and resources 224, and custom circuitry 222, and a thermal management unit 232 via an interconnection/bus module 226. Similarly, the processor 252 may be interconnected to the power management unit 254, the mmWave transceivers 256, memory 258, and various additional processors 260 via the interconnection/bus module 264. The interconnection/bus module 226, 250, 264 may include an array of reconfigurable logic gates and/or implement a bus architecture (such as CoreConnect, AMBA, etc.). Communications may be provided by advanced interconnects, such as high-performance networks-on chip (NoCs).

The first and/or second SOC processing systems 202, 204 may further include an input/output module (not illustrated) for communicating with resources external to the SOC, such as a clock 206 and a voltage regulator 208. Resources external to the SOC (such as clock 206, voltage regulator 208) may be shared by two or more of the internal SOC processors/cores.

In addition to the example SIP 200 discussed above, some implementations may be implemented in a wide variety of computing systems, which may include a single processor, multiple processors, multicore processors, or any combination thereof.

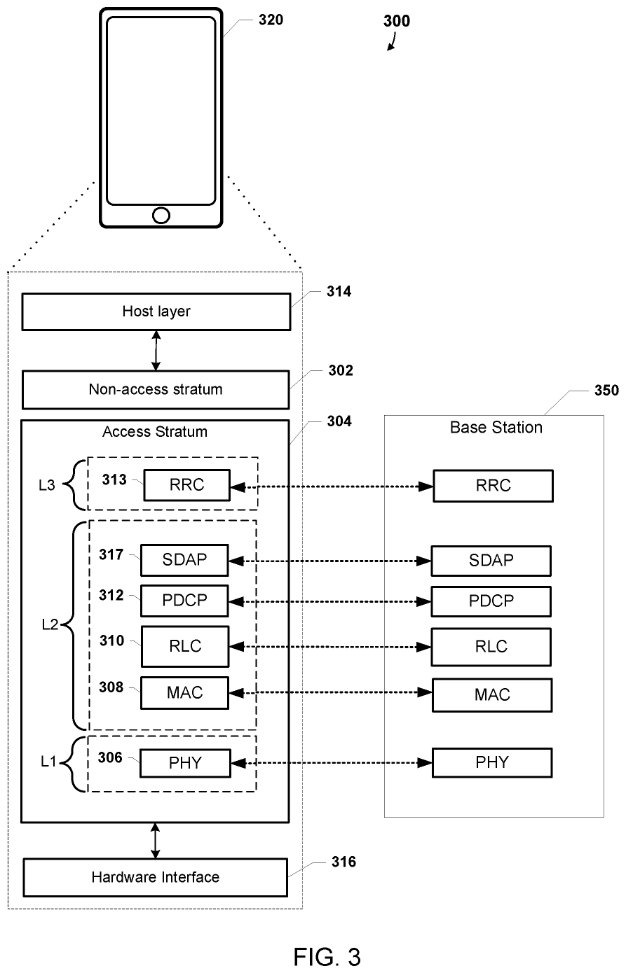

FIG. 3 is a component block diagram illustrating a software architecture 300 including a radio protocol stack for the user and control planes in wireless communications suitable for implementing any of the various embodiments. With reference to FIGS. 1A-3, the wireless device 320 may implement the software architecture 300 to facilitate communication between a wireless device 320 (e.g., the wireless device 120a-120e, 200) and the base station 350 (e.g., the base station 110a-110d) of a communication system (e.g., 100). In various embodiments, layers in software architecture 300 may form logical connections with corresponding layers in software of the base station 350. The software architecture 300 may be distributed among one or more processors (e.g., the processors 212, 214, 216, 218, 252, 260) of a processing system. While illustrated with respect to one radio protocol stack, in a multi-SIM (subscriber identity module) wireless device, the software architecture 300 may include multiple protocol stacks, each of which may be associated with a different SIM (e.g., two protocol stacks associated with two SIMs, respectively, in a dual-SIM wireless communication device). While described below with reference to LTE communication layers, the software architecture 300 may support any of variety of standards and protocols for wireless communications, and/or may include additional protocol stacks that support any of variety of standards and protocols wireless communications.

The software architecture 300 may include a Non-Access Stratum (NAS) 302 and an Access Stratum (AS) 304. The NAS 302 may include functions and protocols to support packet filtering, security management, mobility control, session management, and traffic and signaling between a SIM(s) of the wireless device (such as SIM(s) 204) and its core network 140. The AS 304 may include functions and protocols that support communication between a SIM(s) (such as SIM(s) 204) and entities of supported access networks (such as a base station). In particular, the AS 304 may include at least three layers (Layer 1, Layer 2, and Layer 3), each of which may contain various sub-layers.

In the user and control planes, Layer 1 (L1) of the AS 304 may be a physical layer (PHY) 306, which may oversee functions that enable transmission and/or reception over the air interface via a wireless transceiver (e.g., 266). Examples of such physical layer 306 functions may include cyclic redundancy check (CRC) attachment, coding blocks, scrambling and descrambling, modulation and demodulation, signal measurements, MIMO, etc. The physical layer may include various logical channels, including the Physical Downlink Control Channel (PDCCH) and the Physical Downlink Shared Channel (PDSCH).

In the user and control planes, Layer 2 (L2) of the AS 304 may be responsible for the link between the wireless device 320 and the base station 350 over the physical layer 306. In some implementations, Layer 2 may include a media access control (MAC) sublayer 308, a radio link control (RLC) sublayer 310, and a packet data convergence protocol (PDCP) 312 sublayer, and a Service Data Adaptation Protocol (SDAP) 317 sublayer, each of which form logical connections terminating at the base station 350.

In the control plane, Layer 3 (L3) of the AS 304 may include a radio resource control (RRC) sublayer 3. While not shown, the software architecture 300 may include additional Layer 3 sublayers, as well as various upper layers above Layer 3. In some implementations, the RRC sublayer 313 may provide functions including broadcasting system information, paging, and establishing and releasing an RRC signaling connection between the wireless device 320 and the base station 350.

In various embodiments, the SDAP sublayer 317 may provide mapping between Quality of Service (QoS) flows and data radio bearers (DRBs). In some implementations, the PDCP sublayer 312 may provide uplink functions including multiplexing between different radio bearers and logical channels, sequence number addition, handover data handling, integrity protection, ciphering, and header compression. In the downlink, the PDCP sublayer 312 may provide functions that include in-sequence delivery of data packets, duplicate data packet detection, integrity validation, deciphering, and header decompression.

In the uplink, the RLC sublayer 310 may provide segmentation and concatenation of upper layer data packets, retransmission of lost data packets, and Automatic Repeat Request (ARQ). In the downlink, while the RLC sublayer 310 functions may include reordering of data packets to compensate for out-of-order reception, reassembly of upper layer data packets, and ARQ.

In the uplink, MAC sublayer 308 may provide functions including multiplexing between logical and transport channels, random access procedure, logical channel priority, and hybrid-ARQ (HARQ) operations. In the downlink, the MAC layer functions may include channel mapping within a cell, de-multiplexing, discontinuous reception (DRX), and HARQ operations.

While the software architecture 300 may provide functions to transmit data through physical media, the software architecture 300 may further include at least one host layer 314 to provide data transfer services to various applications in the wireless device 320. In some implementations, application-specific functions provided by the at least one host layer 314 may provide an interface between the software architecture and the general purpose processor 206.

In other implementations, the software architecture 300 may include one or more higher logical layer (such as transport, session, presentation, application, etc.) that provide host layer functions. For example, in some implementations, the software architecture 300 may include a network layer (such as Internet Protocol (IP) layer) in which a logical connection terminates at a packet data network (PDN) gateway (PGW). In some implementations, the software architecture 300 may include an application layer in which a logical connection terminates at another device (such as end user device, server, etc.). In some implementations, the software architecture 300 may further include in the AS 304 a hardware interface 316 between the physical layer 306 and the communication hardware (such as one or more radio frequency (RF) transceivers).

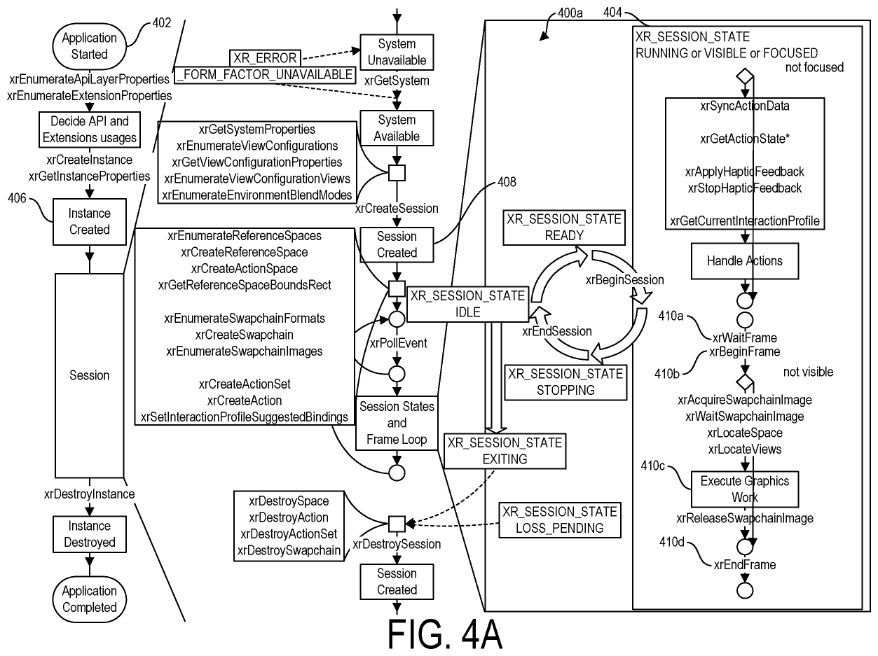

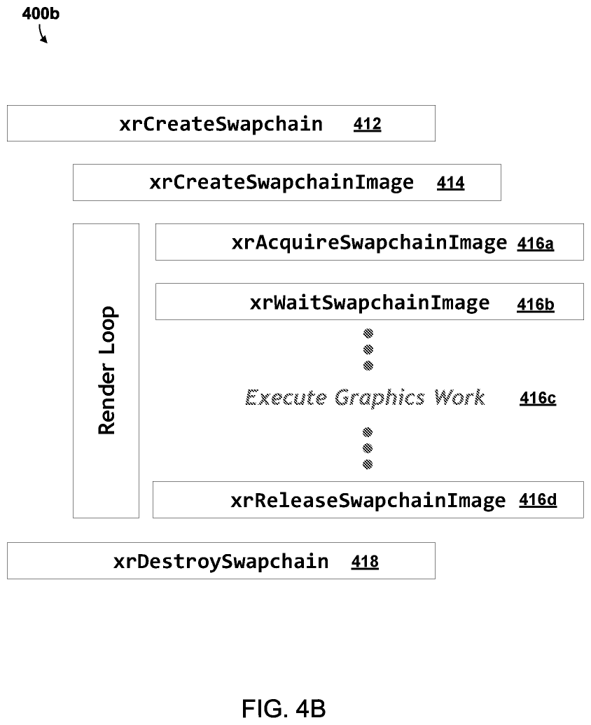

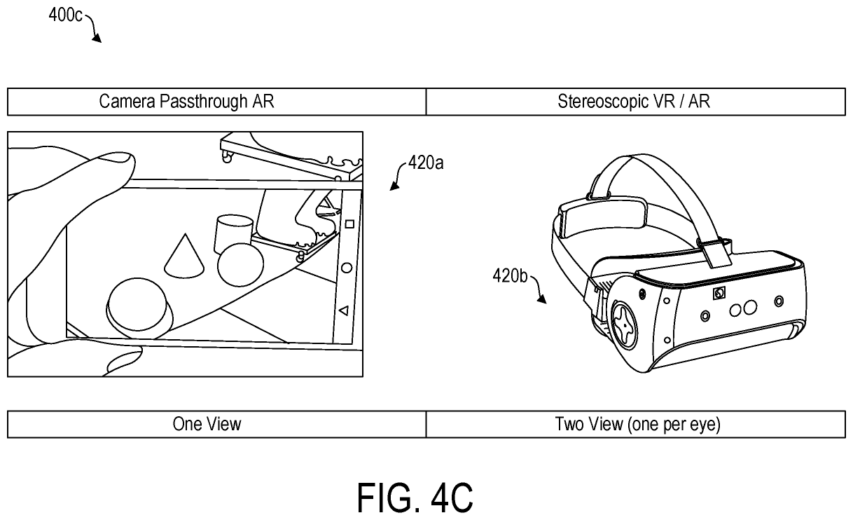

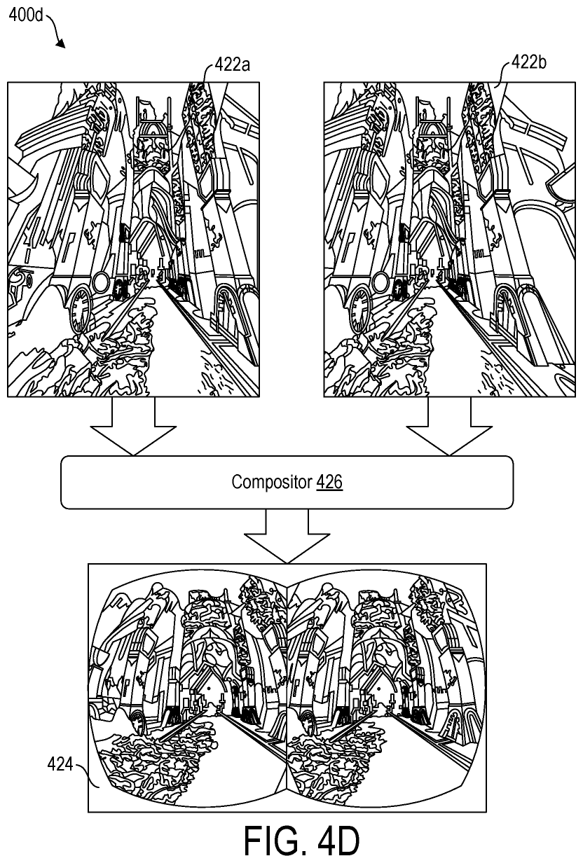

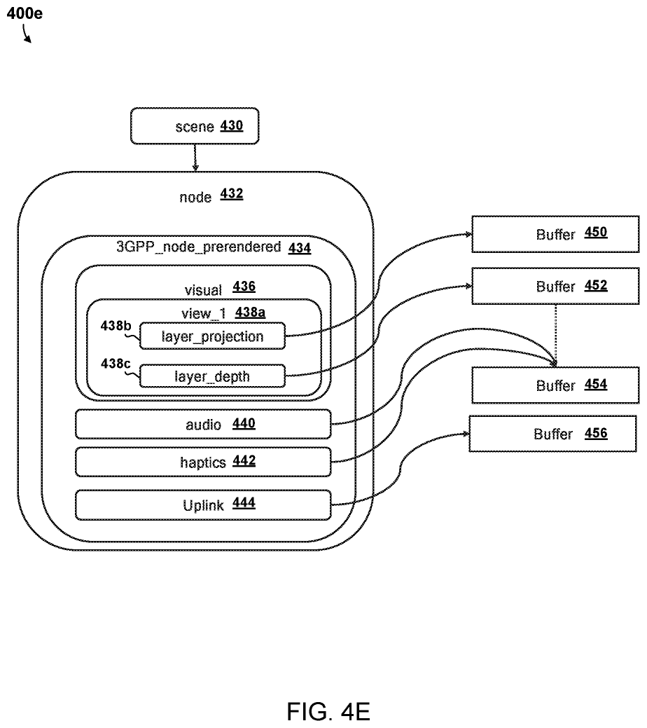

FIG. 4A is a conceptual diagram illustrating operations 400a performed by an application and an XR runtime according to various embodiments. With reference to FIGS. 1A-4A, an application 402 may use an extensible API (for example, an OpenXR API) to communicate with an XR runtime 404. The application 402 may begin by sending a query to the XR runtime 404 that creates an instance (e.g., an xrinstance 406). If the XR runtime is available, a session 408 is created. The XR runtime receives information for rendering from the application, and performs operations of a rendering loop including xrWaitFrame 410a (wait for a display frame opportunity), xrBeginFrame 410b (signals the start of frame rendering), performing rendering operations 410c (“execute graphics work”), and xrEndFrame 410d (rendering is finished and swap chains are handed over to a compositor).

FIG. 4B is a block diagram illustrating operations 400b of a render loop that may be performed by an XR system according to various embodiments. With reference to FIGS. 1A-4B, an application executing in the UE may create an XR session, and for each visual stream the UE may create a swap chain image. The application may receive a pre-rendered frame from each stream, and may pass the pre-rendered frame to the XR runtime for rendering. The network computing device (functioning as a split rendering server) may match a format and a resolution of the swap chain images when pre-rendering content (e.g., 3D content).

In some embodiments, the XR system may perform an xrCreateSwapchain operation 412 that creates a swap chain handle (e.g., an XrSwapchain handle). The xrCreateSwapchain operation 412 may include parameters such as a session identifier of a session that creates an image for processing (e.g., a session parameter), a pointer to a data structure (e.g., XrSwapchainCreateInfo) containing parameters to be used to create the image (e.g., a createInfo parameter), and a created swap chain (e.g., XrSwapchain) is returned. The XR system may perform an xrCreateSwapchainImage operation 414 to create graphics backend-optimized swap chain images. The XR system may then perform operations of the render loop, including xrAcquireSwapchainImage operation 416a to acquire an image for processing, xrWaitSwapchainImage operation 416b to wait for the processing of an image, graphics work operations 416c to perform processing of an image, and xrReleaseSwapchainImage operations 416d to release a rendered image. Upon completion of the render loop operations, the XR system may perform an xrDestroySwapchain operation 418 to release a swap chain image and associated resources. A swap chain may be customized when it is created based on the needs of an application, by specifying various parameters, such as an XR structure type, graphics API-specific texture format identifier, a number of sub-data element samples in the image (e.g., sampleCount), an image width, an image height, face count indicating a number of image faces (e.g., 6 for cubemaps), a number of array layers in the image (e.g., arraySize), a number of levels of detail available for minified sampling of the image (e.g., mipCount), and the like.

FIG. 4C is a conceptual diagram illustrating XR device views 400c according to various embodiments. With reference to FIGS. 1A-4D, an XR system requires configuration information about a view of a UE to perform rendering operations. For example, a smart phone or tablet (e.g., smartphone 420a) executing in XR application may provide a single view on a touchscreen display. A another example, AR glasses or VR goggles (e.g., AR goggles 420b) may provide two views, such as a stereoscopic view, by presenting a view for each of a user's eyes. Information about the UE's view capabilities may be enumerated for the XR system in description information (e.g., xrEnumerateViewConfigurations), which may enumerate supported view configuration types and relevant parameters.

FIG. 4D is a conceptual diagram illustrating operations 400d performed by compositor according to various embodiments. With reference to FIGS. 1A-4D, an XR system may include a compositor 426, which may perform operations including composing layers, reprojecting layers, applying lens distortion, and/or sending final images for display. For example, the compositor 426 may receive as inputs a left eye image 422a and a right eye image 422b, and may provide as output a combined image 424 that includes a combination of the left eye image on the right eye image. In some embodiments, an application may use multiple layers. Supported composition layer types may include stereo, quad (e.g., 2-dimensional planes in 3-dimensional space), cubemap, equirectangular, cylinder, depth, alpha blend, and/or other vendor composition layers.

FIG. 4E is a conceptual diagram illustrating an extension 400e configured to include description information according to various embodiments. With reference to FIGS. 1A-4E, in some embodiments, a network computing device may configure the extension 400e (that may be referred to as, for example, “3GPP nodeprerendered”) with description information that describes a rendered content-node type 434 of a node 432 in a scene 430. In various embodiments, the scene 430 may include a description of a 3D environment. The scene 430 may be formatted as a hierarchical graph, and each graph node may be described by a node 432.

In some embodiments, the rendered content-node type may to indicate the presence of pre-rendered content. In some embodiments, the extension may include visual 436, audio 440, and/or haptic 442 information components. In some embodiments, the visual information components 436 may include information about a first view (“view 1”) 438a, layer projection information 438b, and layer depth information 438c. In some embodiments, each component may describe a set of buffers 450, 452, 454, 456 and related buffer configurations. In some embodiments, each buffer 450, 452, 454, 456 may be associated with particular information or a particular information component. For example, buffer 450 may be associated with the layer projection information 438b, buffer 452 may be associated with the layer depth information 438c, and so forth. In some embodiments, the extension 400e may include information describing uplink buffers 444 for conveying information from the UE to the network computing device, which may include time-dependent metadata such as UE pose information and information about user inputs.

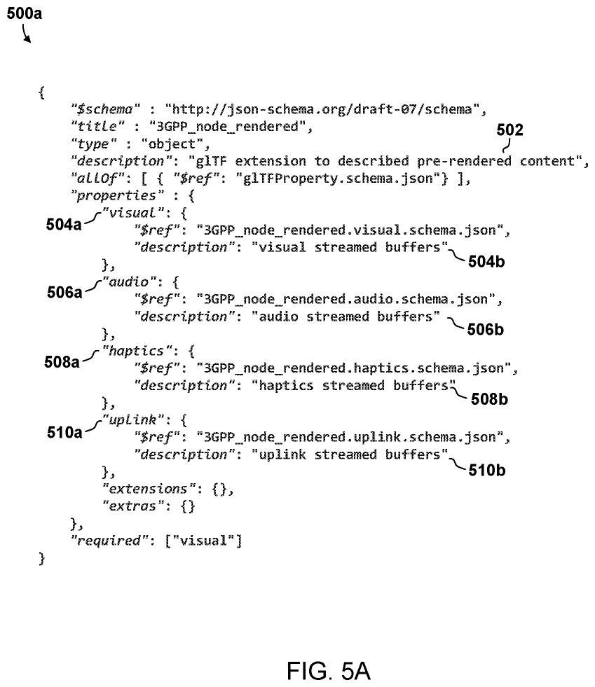

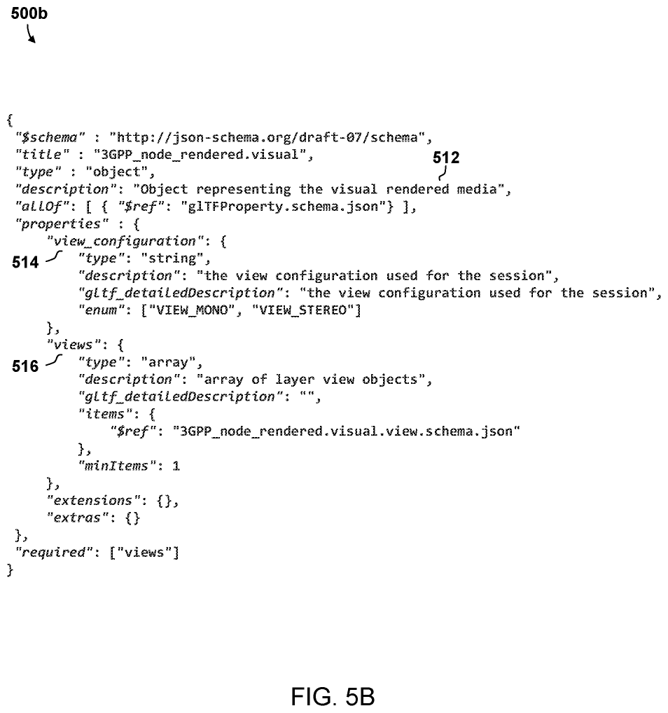

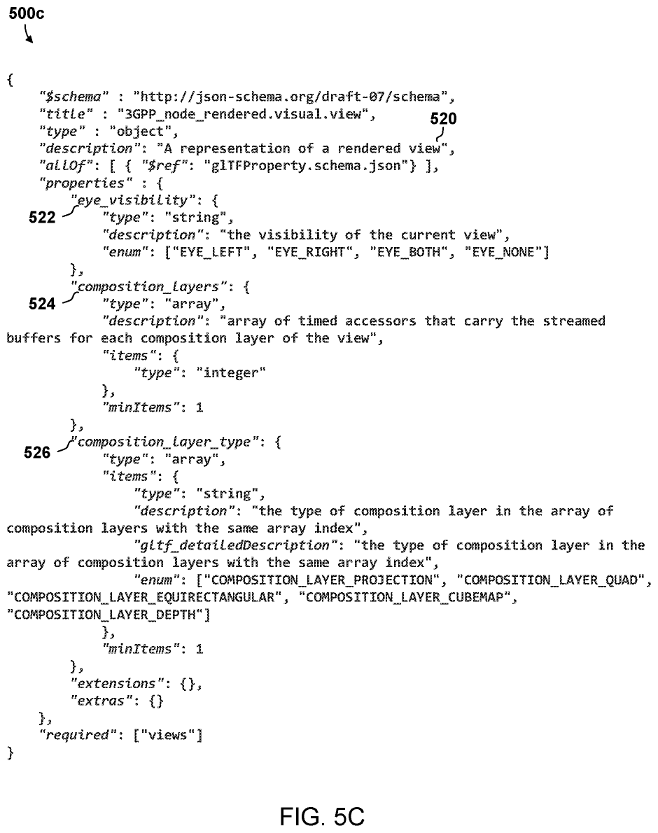

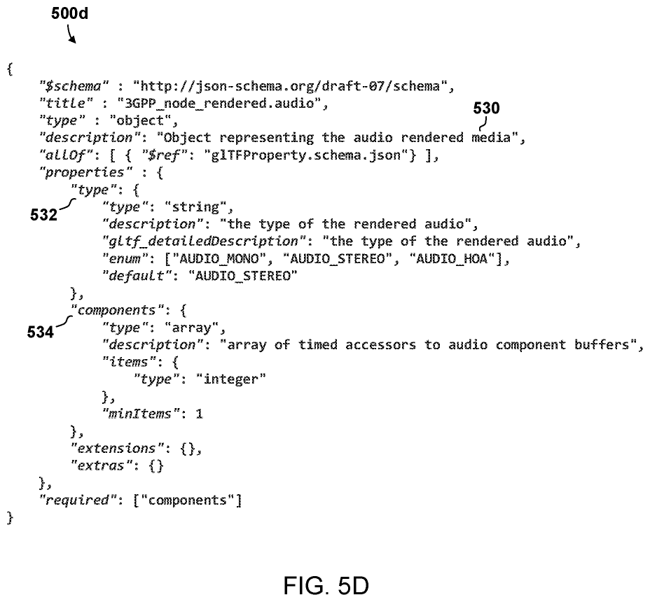

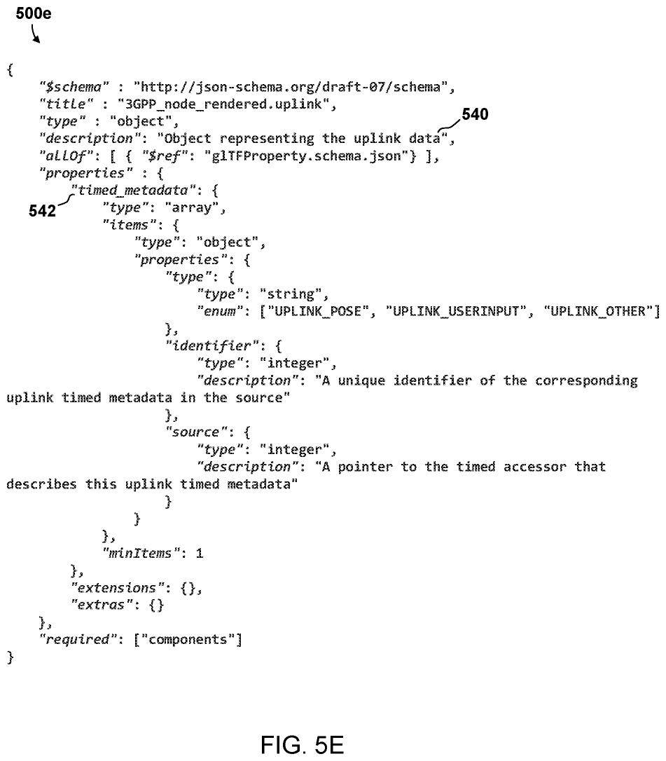

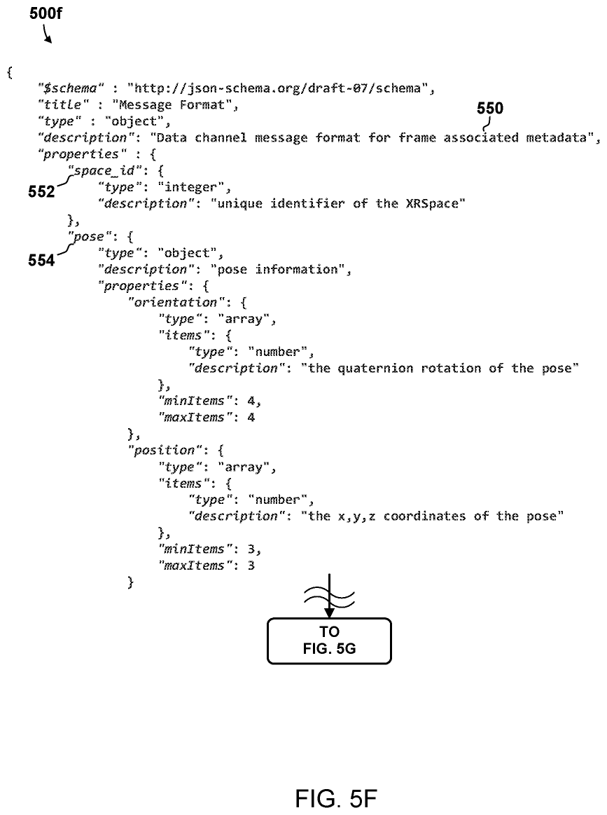

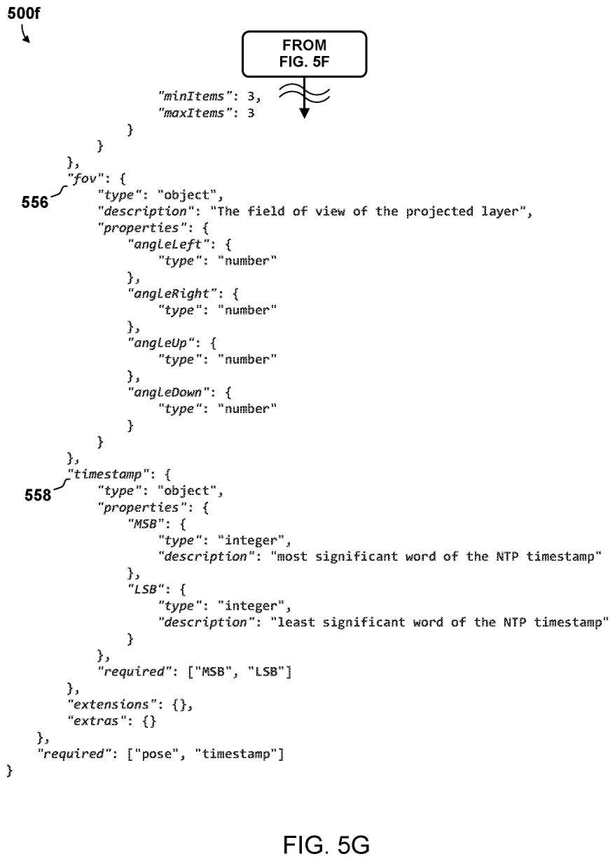

FIGS. 5A-5G illustrates aspects of description information 500a-500f according to various embodiments. With reference to FIGS. 1A-5G, although the description information 500a-500f is discussed using the OpenXR protocol as an example, any suitable arrangement of information may be used in various embodiments.

Referring to FIG. 5A, the description information 500a may be configured to describe pre-rendered content 502, e.g., “glTF extension to describe prerendered content.” The description information 500a may be configured to include parameters or configuration information about visual information 504a (“visual”), audio information 506a (“audio”), and haptic information 508a, such as haptic commands to be executed by a UE (e.g., “haptics”). The description information 500a also may be configured to include configuration information about information 510a that the UE may provide in an uplink to a network computing device. The description information 500a also may be configured to include configuration information or parameters about streamed buffers for each of the information above, for example, “visual streamed buffers” 504b, “audio streamed buffers” 506b, “haptics streamed buffers” 508b, and “uplink streamed buffers” 510b. In some embodiments, the audio information 506a, haptic information 508a, and/or uplink information 510a may be optional.

Referring to FIG. 5B, the description information 500b may be configured to describe visual pre-rendered content 512. The description information 500b may be configured to include information describing a view configuration 514. The description information 500b also may include an enumeration of view type(s). The description information 500b may be configured to include information describing an array of layer view objects 516.

Referring to FIG. 5C, the description information 500c may be configured to describe a representation of a pre-rendered view 520. The description information 500c may be configured to include properties such as eye visibility information 522 (e.g., for a left eye, a right eye, both eyes, or none), a description 524 of an array of glTF timed accessors that carry the streamed buffers for each composition layer of the view, and an array 526 of the type of composition layer in the array of composition layers. In various embodiments, a timed accessor is a descriptor in glTF of how timed media is formatted and from which source the timed media is to be received. The description information 500c may be configured to include information describing a composition layer type in the array of composition layers.

Referring to FIG. 5D, the description information 500d may be configured to include information describing audio pre-rendered media 520. The description information 500d may be configured to include an object description 530, type information 532, including a description of a type of the rendered audio, and an enumeration of audio aspects such as mono, stereo, or information regarding higher order ambisonics (HOA), such as information related to three-dimensional sound scenes or sound fields. The description information 500d also may be configured to include information about components 534 such as information about an array of timed accessors to audio component buffers.

Referring to FIG. 5E, the description information 500e may be configured to include information describing uplink data 540 that the UE may send to the network computing device. The description information 500e may be configured to include a description of timed metadata 542, including a variety of parameters, and an enumeration of types of metadata, such as the UE pose, information about a user input, or other information that the UE may provide to a network computing device in the uplink. The description information 500e also may be configured to include information about source information such as a pointer to a timed accessor that describes the uplink timed metadata.

Referring to FIGS. 5F and 5G, the description information 500f may be configured to include information describing a data channel message format for frame associated metadata 550. The description information 500f may be configured to include information describing a unique identifier of an XR space 552 for which the content is being pre-rendered. The description information 500f may be configured to include information describing pose information of the image 554. The pose information may include property information such as an orientation (e.g., a rotation of the pose), three-dimensional coordinates of the image's pose, and other suitable information. The description information 500f may be configured to include information describing field of view information 556 including information about the field-of-view of a projected layer (e.g., left, right, up, and down angle information). The description information 500f may be configured to include a timestamp information 558 for an image.

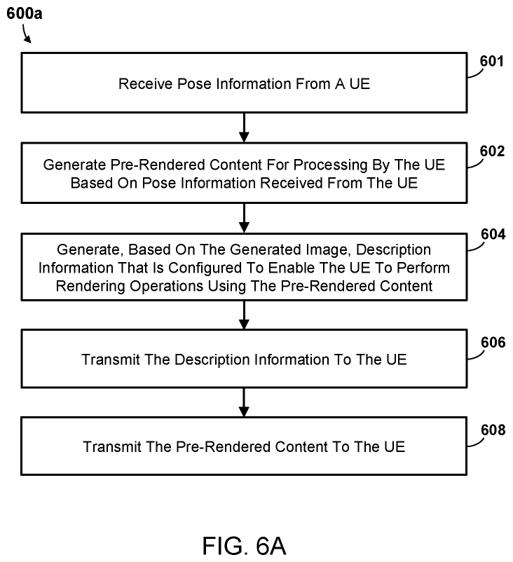

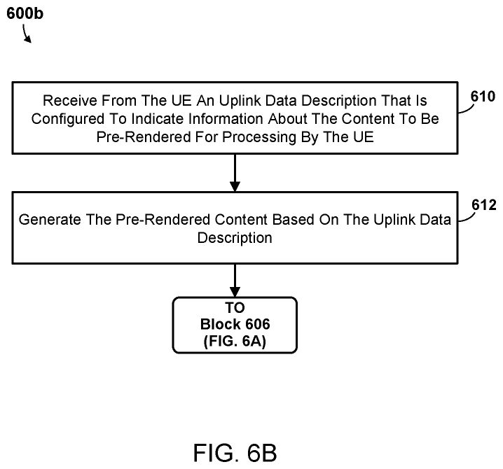

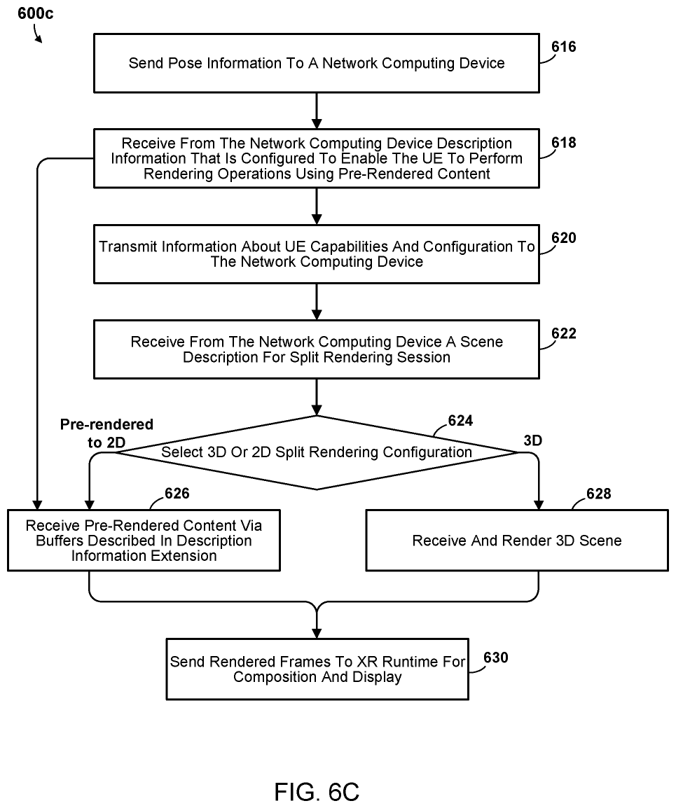

FIG. 6A is a process flow diagram illustrating a method 600a performed by a processing system of a network computing device for communicating pre-rendered media to a UE according to various embodiments. With reference to FIGS. 1A-6A, the operations of the method 600a may be performed by a processing system (e.g., 200, 202, 204) including one or more processors (e.g., 210, 212, 214, 216, 218, 252, 260) and/or hardware elements, any one or combination of which may be configured to perform any of the operations of the method 600a. To encompass any of the processor(s), hardware elements and software elements that may be involved in performing the method 600a, the elements performing method operations are referred to generally as a “processing system.” Further, means for performing the operations of the method 600a include a processing system (e.g., 200, 202, 204) including one or more processors (such as the processor 210, 212, 214, 216, 218, 252, 260) of a network computing device (e.g., 700).

In block 601, the processing system may receive pose information received from a UE.

In block 602, the processing system may generate pre-rendered content for processing by the UE based on pose information received from the UE.

In block 604, the processing system may generate, based on the pre-rendered content, description information that is configured to enable the UE to perform rendering operations using the pre-rendered content. In some embodiments, the processing system may configure the description information to include a variety of information as described with respect to the description information 500a-500g.

In some embodiments, the processing system may configure the description information to indicate buffer information for one or more buffers by which the network computing device will stream the pre-rendered content. The buffers may include visual data buffers, audio data buffers, and/or haptics data buffers. In some embodiments, the processing system may configure the description information to indicate view configure information for the pre-rendered content. In some embodiments, the processing system may configure the description information to indicate an array of layer view objects. In some embodiments, the processing system may configure the description information to indicate eye visibility information for the pre-rendered content. In some embodiments, the processing system may configure the description information to indicate composition layer information for the pre-rendered content In some embodiments, the processing system may configure the description information to indicate composition layer type information for the pre-rendered content. In some embodiments, the processing system may configure the description information to indicate audio configuration properties for the pre-rendered content.

In block 606, the processing system may transmit to the UE the description information. In some embodiments, the processing system may transmit to the UE a packet header extension including information that is configured to enable the UE to present the pre-rendered content. In some embodiments, the processing system may transmit to the UE a data channel message including information that is configured to enable the UE to present the pre-rendered content.

In block 608, the processing system may transmit the pre-rendered to the UE.

FIG. 6B is a process flow diagram illustrating operations 600b that may be performed by a processing system of a network element as part of the method 600a for communicating pre-rendered media to a UE according to various embodiments. With reference to FIGS. 1A-6B, the operations of the method 600b may be performed by a processing system (e.g., 200, 202, 204) including one or more processors (e.g., 210, 212, 214, 216, 218, 252, 260) and/or hardware elements, any one or combination of which may be configured to perform any of the operations of the method 600b. To encompass any of the processor(s), hardware elements and software elements that may be involved in performing the method 600b, the elements performing method operations are referred to generally as a “processing system.” Further, means for performing the operations 600b include processing system (e.g., 200, 202, 204) including one or more a processors (such as the processor 210, 212, 214, 216, 218, 252, 260) of a network computing device (e.g., 700).

In block 610, the processing system may receive from the UE an uplink data description that is configured to indicate information about the content to be pre-rendered for processing by the UE.

In block 612, the processing system may generate the pre-rendered content (for processing by the UE) based on the uplink data description.

The processing system may transmit to the UE the description information and the rendered content in block 606 as described.

FIG. 6C is a process flow diagram illustrating operations 600c that may be performed by a processing system of a UE according to various embodiments. With reference to FIGS. 1A-6C, the operations of the method 600c may be performed by a processing system (e.g., 200, 202, 204) including one or more processors (e.g., 210, 212, 214, 216, 218, 252, 260) and/or hardware elements, any one or combination of which may be configured to perform any of the operations of the method 600c. To encompass any of the processor(s), hardware elements and software elements that may be involved in performing the method 600b, the elements performing method operations are referred to generally as a “processing system.” Further, means for performing the operations 600c include a processing system (e.g., 200, 202, 204) including one or more processors (such as the processor 210, 212, 214, 216, 218, 252, 260) of a UE (e.g., 800, 900).

In block 616, the processing system may send pose information to a network computing device. In some embodiments, the pose information may include information regarding a location, orientation, movement, or like information useful for the network computing device to render content suitable for display on the UE.

In block 618, the processing system may receive from the network computing device description information that is configured to enable the UE to perform rendering operations using pre-rendered content that will be provided by the network computing device.

In block 626, the processing system may receive from the network computing device pre-rendered content via buffers described in the description information extension.

In block 630, the processing system may send rendered frames to an XR runtime for composition and display (e.g., on a display device of the UE).

In some embodiments, the UE may have capabilities to receive 2D or 3D content, and may perform operations to inform the network computing device about such capabilities and then render received content according to a selected rendering configuration. In such embodiments, the UE processing system may also perform operations in blocks 620-628.

In block 620, the processing system may transmit information about UE capabilities and configuration to the network computing device. In some embodiments, the UE information may include information about the UE's display capabilities, rendering capabilities, processing capabilities, and/or other suitable capabilities relevant to split rendering operations.

In block 622, the processing system may receive from the network computing device a scene description for a split rendering session (e.g., description information).

In determination block 624, the processing system may determine whether to select a 3D rendering configuration or a 2D rendering configuration. In some embodiments, the processing system may select the 3D rendering configuration or the 2D rendering configuration based at least in part on the received scene description for the split rendering session (e.g., based at least in part on the description information).

In response to determining to selecting the 2D rendering configuration (i.e., determination block 624=“Pre-rendered to 2D”), the processing system may receive pre-rendered content via buffers described in a description information extension (e.g., “3GPP nodeprerendered”) of the scene description in block 626.

In response to determining to selecting the 3D rendering configuration (i.e., determination block 624=“3D”), the processing system may receive from the network computing device information for rendering 3D scene images and may render the 3D scene image(s) using the information for rendering the 3D scene images.

Following the performance of the operations of blocks 626 or 628, the processing system may send rendered frames to an XR runtime for composition and display (e.g., on a display device of the UE) in block 630.

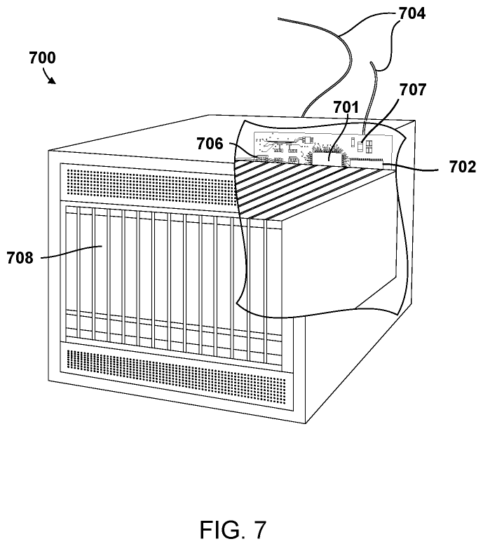

FIG. 7 is a component block diagram of a network computing device suitable for use with various embodiments. With reference to FIGS. 1A-7, network computing devices may implement functions (e.g., 414, 416, 418) in a communication network (e.g., 100, 150) and may include at least the components illustrated in FIG. 7. The network computing device 700 may include a processing system 701 coupled to volatile memory 702 and a large capacity nonvolatile memory, such as a disk drive 708. The network computing device 700 also may include a peripheral memory access device 706 such as a floppy disc drive, compact disc (CD) or digital video disc (DVD) drive coupled to the processing system 701. The network computing device 700 also may include network access ports 704 (or interfaces) coupled to the processing system 701 for establishing data connections with a network, such as the Internet or a local area network coupled to other system computers and servers. The network computing device 700 may include one or more antennas 707 for sending and receiving electromagnetic radiation that may be connected to a wireless communication link. The network computing device 700 may include additional access ports, such as USB, Firewire, Thunderbolt, and the like for coupling to peripherals, external memory, or other devices.

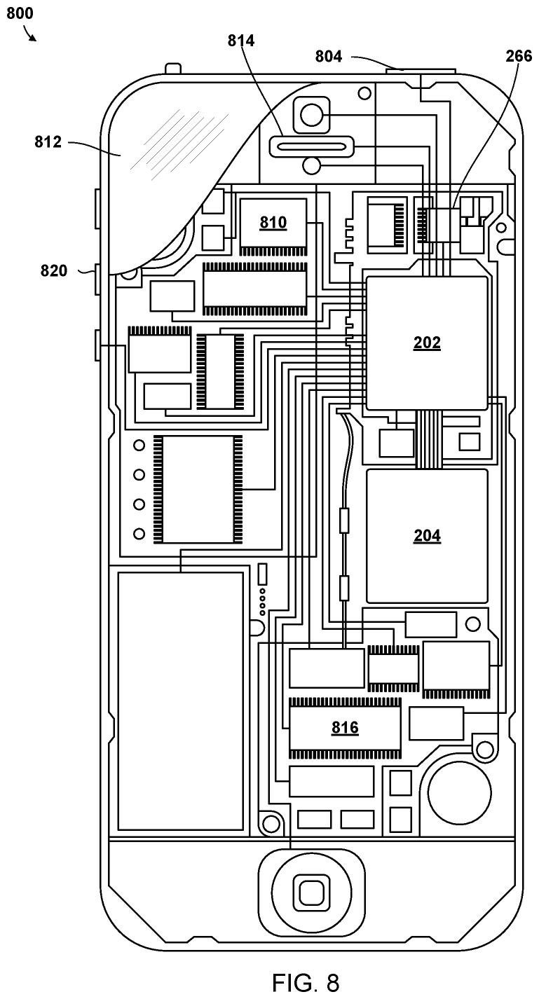

FIG. 8 is a component block diagram of a UE 800 suitable for use with various embodiments. With reference to FIGS. 1A-8, various embodiments may be implemented on a variety of UEs 800 (for example, the wireless device 120a-120e, 200, 320, 404), one example of which is illustrated in FIG. 8 in the form of a smartphone. However, it will be appreciated that the UE 800 may be implemented in a variety of embodiments, such as an XR device, VR goggles, smart glasses, and/or the like. The UE 800 may include a first SOC processing system 202 (for example, a SOC-CPU) coupled to a second SOC processing system 204 (for example, a 5G capable SOC). The first and second SOC processing systems 202, 204 may be coupled to internal memory 816, a display 812, and to a speaker 814. Additionally, the UE 800 may include an antenna 804 for sending and receiving electromagnetic radiation that may be connected to a transceiver 427 coupled to one or more processors in the first and/or second SOC processing systems 202, 204. UE 800 may include menu selection buttons or rocker switches 820 for receiving user inputs.

The UE 800 may include a sound encoding/decoding (CODEC) circuit 810, which digitizes sound received from a microphone into data packets suitable for wireless transmission and decodes received sound data packets to generate analog signals that are provided to the speaker to generate sound. One or more of the processors in the first and second SOC processing systems 202, 204, wireless transceiver 266 and CODEC 810 may include a digital signal processor (DSP) circuit (not shown separately).

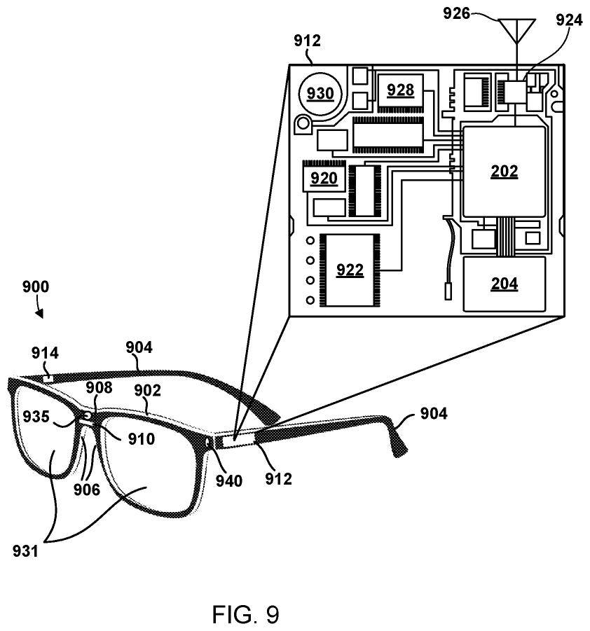

FIG. 9 is a component block diagram of a UE suitable for use with various embodiments. With reference to FIGS. 1A-9, various embodiments may be implemented on a variety of UEs, an example of which is illustrated in FIG. 9 in the form of smart glasses 900. The smart glasses 900 may operate like conventional eye glasses, but with enhanced computer features and sensors, like a built-in camera 935 and heads-up display or XR features on or near the lenses 931. Like any glasses, smart glasses 900 may include a frame 902 coupled to temples 904 that fit alongside the head and behind the ears of a wearer. The frame 902 holds the lenses 931 in place before the wearer's eyes when nose pads 906 on the bridge 908 rest on the wearer's nose.

In some embodiments, smart glasses 900 may include an image rendering device 914 (e.g., an image projector), which may be embedded in one or both temples 904 of the frame 902 and configured to project images onto the optical lenses 931. In some embodiments, the image rendering device 914 may include a light-emitting diode (LED) module, a light tunnel, a homogenizing lens, an optical display, a fold mirror, or other components well known projectors or head-mounted displays. In some embodiments (e.g., those in which the image rendering device 914 is not included or used), the optical lenses 931 may be, or may include, see-through or partially see-through electronic displays. In some embodiments, the optical lenses 931 include image-producing elements, such as see-through Organic Light-Emitting Diode (OLED) display elements or liquid crystal on silicon (LCOS) display elements. In some embodiments, the optical lenses 931 may include independent left-eye and right-eye display elements. In some embodiments, the optical lenses 931 may include or operate as a light guide for delivering light from the display elements to the eyes of a wearer.

The smart glasses 900 may include a number of external sensors that may be configured to obtain information about wearer actions and external conditions that may be useful for sensing images, sounds, muscle motions and other phenomenon that may be useful for detecting when the wearer is interacting with a virtual user interface as described. In some embodiments, smart glasses 900 may include a camera 935 configured to image objects in front of the wearer in still images or a video stream. Additionally, the smart glasses 900 may include a lidar sensor 940 or other ranging device. In some embodiments, the smart glasses 900 may include a microphone 910 positioned and configured to record sounds in the vicinity of the wearer. In some embodiments, multiple microphones may be positioned in different locations on the frame 902, such as on a distal end of the temples 904 near the jaw, to record sounds made when a user taps a selecting object on a hand, and the like. In some embodiments, smart glasses 900 may include pressure sensors, such on the nose pads 906, configured to sense facial movements for calibrating distance measurements. In some embodiments, smart glasses 900 may include other sensors (e.g., a thermometer, heart rate monitor, body temperature sensor, pulse oximeter, etc.) for collecting information pertaining to environment and/or user conditions that may be useful for recognizing an interaction by a user with a virtual user interface

The smart glasses 900 may include a processing system 912 that includes processing and communication SOCs 202, 204 which may include one or more processors (e.g., 212, 214, 216, 218, 260) one or more of which may be configured with processor-executable instructions to perform operations of various embodiments. The processing and communications SOCs 202, 204 may be coupled to internal sensors 920, internal memory 922, and communication circuitry 924 coupled one or more antenna 926 for establishing a wireless data link. The processing and communication SOCs 202, 204 may also be coupled to sensor interface circuitry 928 configured to control and receive data from a camera 935, microphone(s) 910, and other sensors positioned on the frame 902.

The internal sensors 920 may include an inertial measurement unit (IMU) that includes electronic gyroscopes, accelerometers, and a magnetic compass configured to measure movements and orientation of the wearer's head. The internal sensors 920 may further include a magnetometer, an altimeter, an odometer, and an atmospheric pressure sensor, as well as other sensors useful for determining the orientation and motions of the smart glasses 900. The processing system 912 may further include a power source such as a rechargeable battery 930 coupled to the SOCs 202, 204 as well as the external sensors on the frame 902.

The processing systems of the network computing device 700 and the UEs 800 and 900 may include any programmable microprocessor, microcomputer or multiple processor chip or chips that can be configured by software instructions (applications) to perform a variety of functions, including the functions of some implementations described below. In some wireless devices, multiple processors may be provided, such as one processor within an SOC processing system 204 dedicated to wireless communication functions and one processor within an SOC 202 dedicated to running other applications. Software applications may be stored in the memory 702, 816, 922 before they are accessed and loaded into the processor. The processors may include internal memory sufficient to store the application software instructions.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more aspects of the description information 500a-500f and any of the methods and operations 600a-600c may be substituted for or combined with one or more aspects of the description information 500a-500f and any of the methods and operations 600a-600c.

Implementation examples are described in the following paragraphs. While some of the following implementation examples are described in terms of example methods, further example implementations may include: the example methods discussed in the following paragraphs implemented by a base station including a processor configured with processor-executable instructions to perform operations of the methods of the following implementation examples; the example methods discussed in the following paragraphs implemented by a base station including means for performing functions of the methods of the following implementation examples; and the example methods discussed in the following paragraphs may be implemented as a non-transitory processor-readable storage medium having stored thereon processor-executable instructions configured to cause a processor of a base station to perform the operations of the methods of the following implementation examples.

Example 1. A method for communicating rendered media to a user equipment (UE) performed by a processing system of a network computing device, including receiving pose information from the UE, generating pre-rendered content for processing by the UE based on the pose information received from the UE, generating, based on the pre-rendered content, description information that is configured to enable the UE to perform rendering operations using the pre-rendered content, transmitting the description information to the UE, and transmitting the pre-rendered content to the UE.

Example 2. The method of example 1, in which the description information is configured to indicate buffer information for one or more buffers by which the network computing device will stream the pre-rendered content.

Example 3. The method of either of examples 1 and/or 2, in which the description information is configured to indicate view configuration information for the pre-rendered content.

Example 4. The method of any of examples 1-3, in which the description information is configured to indicate an array of layer view objects.

Example 5. The method of any of examples 1-4, in which the description information is configured to indicate eye visibility information for the pre-rendered content.

Example 6. The method of any of examples 1-5, in which the description information is configured to indicate composition layer information for the pre-rendered content.

Example 7. The method of any of examples 1-6, in which the description information is configured to indicate composition layer type information for the pre-rendered content.

Example 8. The method of any of examples 1-7, in which the description information is configured to indicate audio configuration properties for the pre-rendered content.

Example 9. The method of any of examples 1-8, further including receiving from the UE an uplink data description that is configured to indicate information about the content to be pre-rendered for processing by the UE, in which generating the pre-rendered content for processing by the UE based on pose information received from the UE includes generating the pre-rendered content based on the uplink data description.

Example 10. The method of any of examples 1-9, in which transmitting to the UE the description information includes transmitting to the UE a packet header extension including information that is configured to enable the UE to process the pre-rendered content.

Example 11. The method of any of examples 1-10, in which transmitting to the UE the description information includes transmitting to the UE a data channel message including information that is configured to enable the UE to process the pre-rendered content.

Example 12. A method performed by a processor of a user equipment (UE), including sending pose information to a network computing device, receiving from the network computing device description information that is configured to enable the UE to perform rendering operations using pre-rendered content, receiving pre-rendered content via buffers described in the description information extension, and sending rendered frames to an extended reality (XR) runtime for composition and display.

Example 13. The method of example 12, further including transmitting information about UE capabilities and configuration to the network computing device, and receiving from the network computing device a scene description for a split rendering session.

Example 14. The method of example 13, further including determining whether to select a 3D rendering configuration or a 2D rendering configuration based at least in part on the received scene description, receiving pre-rendered content via buffers described in a description information extension of the scene description in response to determining to select the 2D rendering configuration, and receiving information for rendering 3D scene images and rendering the one or more 3D scene images in response to determining to select the 3D rendering configuration.

[More examples may be added depending on changes to the method claims.]

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, or a computer. By way of illustration, both an application running on a wireless device and the wireless device may be referred to as a component. One or more components may reside within a process or thread of execution and a component may be localized on one processor or core or distributed between two or more processors or cores. In addition, these components may execute from various non-transitory computer readable media having various instructions or data structures stored thereon. Components may communicate by way of local or remote processes, function or procedure calls, electronic signals, data packets, memory read/writes, and other known network, computer, processor, or process related communication methodologies.

A number of different cellular and mobile communication services and standards are available or contemplated in the future, all of which may implement and benefit from the various embodiments. Such services and standards include, e.g., third generation partnership project (3GPP), long term evolution (LTE) systems, third generation wireless mobile communication technology (3G), fourth generation wireless mobile communication technology (4G), fifth generation wireless mobile communication technology (5G) as well as later generation 3GPP technology, global system for mobile communications (GSM), universal mobile telecommunications system (UMTS), 3GSM, general packet radio service (GPRS), code division multiple access (CDMA) systems (e.g., cdmaOne, CDMA1020™), enhanced data rates for GSM evolution (EDGE), advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), and integrated digital enhanced network (iDEN). Each of these technologies involves, for example, the transmission and reception of voice, data, signaling, and/or content messages. It should be understood that any references to terminology and/or technical details related to an individual telecommunication standard or technology are for illustrative purposes only, and are not intended to limit the scope of the claims to a particular communication system or technology unless specifically recited in the claim language.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, components, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method for communicating rendered media to a user equipment (UE) performed by a processor of a network computing device, comprising:
receiving pose information from the UE;
generating pre-rendered content for processing by the UE based on the pose information received from the UE;
generating, based on the pre-rendered content, description information that is configured to enable the UE to perform rendering operations using the pre-rendered content;
transmitting the description information to the UE; and
transmitting the pre-rendered content to the UE.

2. The method of claim 1, wherein the description information is configured to indicate buffer information for one or more buffers by which the network computing device will stream the pre-rendered content.

3. The method of claim 1, wherein the description information is configured to indicate view configuration information for the pre-rendered content.

4. The method of claim 1, wherein the description information is configured to indicate an array of layer view objects.

5. The method of claim 1, wherein the description information is configured to indicate eye visibility information for the pre-rendered content.

6. The method of claim 1, wherein the description information is configured to indicate composition layer information for the pre-rendered content.

7. The method of claim 1, wherein the description information is configured to indicate composition layer type information for the pre-rendered content.

8. The method of claim 1, wherein the description information is configured to indicate audio configuration properties for the pre-rendered content.

9. The method of claim 1, further comprising:
receiving from the UE an uplink data description that is configured to indicate information about the content to be pre-rendered for processing by the UE;
wherein generating the pre-rendered content for processing by the UE based on pose information received from the UE comprises generating the pre-rendered content based on the uplink data description.

10. The method of claim 1, wherein transmitting to the UE the description information comprises transmitting to the UE a packet header extension including information that is configured to enable the UE to process the pre-rendered content.

11. The method of claim 1, wherein transmitting to the UE the description information comprises transmitting to the UE a data channel message including information that is configured to enable the UE to process the pre-rendered content.

12. A network computing device, comprising:
a memory;
a processing system coupled to the memory and including one or more processors configured to:
receive pose information from a user equipment (UE);
generate pre-rendered content for processing by the UE based on the pose information received from the UE;
generate, based on the pre-rendered content, description information that is configured to enable the UE to perform rendering operations using the pre-rendered content;
transmit the description information to the UE; and
transmit the pre-rendered content to the UE.

13. The network computing device of claim 12, wherein the one or more processors are configured such that the description information is configured to indicate buffer information for one or more buffers by which the network computing device will stream the pre-rendered content.

14. The network computing device of claim 12, wherein the one or more processors are configured such that the description information is configured to indicate view configuration information for the pre-rendered content.

15. The network computing device of claim 12, wherein the one or more processors are configured such that the description information is configured to indicate an array of layer view objects.

16. The network computing device of claim 12, wherein the one or more processors are configured such that the description information is configured to indicate eye visibility information for the pre-rendered content.

17. The network computing device of claim 12, wherein the one or more processors are configured such that the description information is configured to indicate composition layer information for the pre-rendered content.

18. The network computing device of claim 12, wherein the one or more processors are configured such that the description information is configured to indicate composition layer type information for the pre-rendered content.

19. The network computing device of claim 12, wherein the one or more processors are configured such that the description information is configured to indicate audio configuration properties for the pre-rendered content.

20. The network computing device of claim 12, wherein the one or more processors are further configured to:
receive from the UE an uplink data description that is configured to indicate information about the content to be pre-rendered for processing by the UE; and
generate the pre-rendered content for processing by the UE based on the uplink data description.

21. The network computing device of claim 12, wherein the one or more processors are further configured to transmit to the UE the description information and the pre-rendered content as a packet header extension including information that is configured to enable the UE to process the pre-rendered content.

22. The network computing device of claim 12, wherein the one or more processors are further configured to including information that is configured to enable the UE to process the pre-rendered content in the description information transmitted to the UE a data channel message.

23. A method performed by a processor of a user equipment (UE), comprising:
sending pose information to a network computing device;
receiving from the network computing device description information that is configured to enable the UE to perform rendering operations using pre-rendered content;
receiving pre-rendered content via buffers described in the description information extension; and
sending rendered frames to an extended reality (XR) runtime for composition and display.

24. The method of claim 23, further comprising:
transmitting information about UE capabilities and configuration to the network computing device; and
receiving from the network computing device a scene description for a split rendering session.

25. The method of claim 24, further comprising:
determining whether to select a 3D rendering configuration or a 2D rendering configuration based at least in part on the received scene description;
receiving pre-rendered content via buffers described in the description information extension of the scene description in response to determining to select the 2D rendering configuration; and
receiving information for rendering 3D scene images and rendering the one or more 3D scene images in response to determining to select the 3D rendering configuration.

26. A user equipment (UE), comprising:
a memory;
a transceiver; and
a processing system coupled to the memory and the transceiver, and including one or more processors configured to:
send pose information to a network computing device;
receive from a network computing device description information that is configured to enable the UE to perform rendering operations using pre-rendered content;
receive pre-rendered content via buffers described in the description information extension; and
send rendered frames to an extended reality (XR) runtime for composition and display.

27. The UE of claim 26, wherein the one or more processors are further configured to:
transmit information about UE capabilities and configuration to the network computing device; and
receive from the network computing device a scene description for a split rendering session.

28. The UE of claim 27, wherein the one or more processors are further configured to:
determine whether to select a 3D rendering configuration or a 2D rendering configuration based at least in part on the received scene description;
receive pre-rendered content via buffers described in the description information extension of the scene description in response to determining to select the 2D rendering configuration; and
receive information for rendering 3D scene images and rendering the one or more 3D scene images in response to determining to select the 3D rendering configuration.
